(19) United States
(12) Patent Application Publication
(10) Pub. No.: US 2016/0100230 A1
(43) Pub. Date: Apr. 7, 2016

(54) QOE-AWARE WIFI ENHANCEMENTS FOR VIDEO APPLICATIONS

(71) Applicant: VID SCALE INC., Wilmington, DE (US)

(72) Inventors: Liangping Ma, San Diego, CA (US); Avi Rapaport, Shoham (IL); Gregory S. Sternberg, Mt. Laurel, NJ (US); Weimin Liu, Chatham, NJ (US); Anantharaman Balasubramanian, San Diego, CA (US); Yuriy Reznik, Seattle, WA (US); Ariela Zeira, Huntington, NY (US); Tianyi Xu, San Diego, CA (US)

(73) Assignee: VID SCALE, INC., Wilmington, DE (US)

(21) Appl. No.: 14/889,509

(22) PCT Filed: May 7, 2014
(86) PCT No.: PCT/US2014/037098

§ 371 Date: Nov. 6, 2015

Related U.S. Application Data
(60) Provisional application No. 61/982,840, filed on Apr. 22, 2014.
(60) Provisional application No. 61/820,612, filed on May 7, 2013.

(51) Int. Cl. H04N 21/6375; H04N 21/4425; H04N 21/6377; H04N 21/61; H04N 21/442

(52) U.S. Cl. CPC H04N 21/6375; H04N 21/6125; H04N 21/44209; H04N 21/6377; H04N 21/4425

(57) ABSTRACT

An importance level may be associated with a video packet at the video source and/or determined using the history of packet loss corresponding to a video flow. A video packet may be associated with a class and may be further associated within a sub-class, for example, based on importance level. Associating a video packet with an importance level may include receiving a video packet associated with a video stream, assigning an importance level to the video packet, and sending the video packet according to the access category and importance level. The video packet may be characterized by an access category. The importance level may be associated with a transmission priority of the video packet within the access category of the video packet and/or a retransmission limit of the video packet.

### CROSS-REFERENCE TO RELATED APPLICATIONS

This application claims the benefit of U.S. Provisional Patent Application No. 61/820,612, filed May 7, 2013, and U.S. Provisional Patent Application No. 61/982,840, filed Apr. 22, 2014, the disclosures of which are hereby incorporated by reference in their entirety.

### BACKGROUND

The media access control (MAC) sublayer may include an enhanced distributed channel access (EDCA) function, a hybrid coordination function (HCF) controlled channel access (HCCA) function, and/or a mesh coordination function (MCF) controlled channel access (MCCA) function. The MCCA may be utilized for mesh networks. The MAC sublayer may not be optimized for real-time video applications.

### SUMMARY

Systems, methods, and instrumentalities are disclosed for enhancements to real-time video applications. One or more modes or functions of WiFi, such as Enhanced Distributed Channel Access (EDCA), Hybrid Coordination Function (HCF) Controlled Channel Access (HCCA), and/or Distributed Content Function (DCF) (e.g., DCF only MAC), for example, may be enhanced. An importance level may be associated with a video packet at the video source (e.g., the video sending device) and/or may be determined (e.g., dynamically determined), for example, based on the history of packet loss incurred for that video flow. A video packet may be associated with a class, such as Access Category Video (AC_VI), for example, and then further associated within a subclass, for example, based on importance level.

A method for associating a video packet with an importance level may include receiving a video packet associated with a video stream, e.g., from an application layer. The method may include assigning an importance level to the video packet. The importance level may be associated with a transmission priority of the video and/or a retransmission limit of the video packet. The video packet may be sent according to the retransmission limit. For example, sending the video packet may include transmitting the video packet, routing the video packet, sending the video packet to a buffer for transmission, etc.

The access category may be a video access category. For example, the access category may be AC_VI. The importance level may be characterized by a contention window. The importance level may be characterized by an Arbitration Inter-Frame Space Number (AIFSN). The importance level may be characterized by a Transmission Opportunity (TXOP) limit. The importance level may be characterized by a retransmission limit. For example, the importance level may be characterized by one or more of a contention window, an AIFSN, a TXOP, and/or a retransmission limit that is specific to the importance level. The retransmission limit may be assigned based at least in part on the importance level and/or on a loss event.

The video stream may include a plurality of video packets. A first subset of the plurality of video packets may be associated with a first importance level and a second subset of the plurality of video packets may be associated with a second importance level. The first subset of video packets may include I frames, while the second subset of video packets may include P frames and/or B frames.

### BRIEF DESCRIPTION OF THE DRAWINGS

FIG. 1 is a diagram illustrating an example MAC architecture.

FIG. 2 is a diagram illustrating an example of a system.

FIG. 3 is a diagram illustrating an example system architecture for an example static video traffic prioritization approach for EDCA.

FIG. 4 is a diagram illustrating an example system architecture for an example dynamic video traffic prioritization approach for EDCA.

FIG. 5 is a diagram illustrating an example of binary prioritization.

FIG. 6 is a diagram illustrating an example of no differentiation.

FIG. 7 illustrates an example of PSNR as a function of frame number.

FIG. 8 illustrates an example of three-level dynamic prioritization.

FIG. 9 illustrates an example Markov chain model for modeling video packet classes.

FIG. 10 illustrates an example frozen frame comparison.

FIG. 11 illustrates an example network topology of a network.

FIG. 12 illustrates an example video sequence.

FIG. 13 illustrates example simulated collision probabilities.

FIG. 14 illustrates example simulated percentages of frozen frames.

FIG. 15 illustrates example simulated average percentages of frozen frames for different RTTs between video sender and receiver.

FIG. 16 is a diagram illustrating an example reallocation method whereby packets are reallocated to ACs upon packet arrival.

FIG. 17 is a diagram illustrating an example reallocation method whereby the newest packets are allocated to ACs upon packet arrival to be optimized.

FIG. 18 is a diagram illustrating an example system architecture for an example static video traffic differentiation approach for DCF.

FIG. 19 is a diagram illustrating an example system architecture for an example dynamic video traffic differentiation approach for DCF.

FIG. 20A is a system diagram of an example communications system in which one or more disclosed embodiments may be implemented.

FIG. 20B is a system diagram of an example wireless transmit/receive unit (WTRU) that may be used within the communications system illustrated in FIG. 20A.

FIG. 20C is a system diagram of an example radio access network and an example core network that may be used within the communications system illustrated in FIG. 20A.

FIG. 20D is a system diagram of another example radio access network and an example core network that may be used within the communications system illustrated in FIG. 20A.

FIG. 20E is a system diagram of another example radio access network and an example core network that may be used within the communications system illustrated in FIG. 20A.

FIG. 21 illustrates an example Markov chain model for video packet classes.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

The quality of experience (QoE) for video applications, such as real-time video applications (e.g., video telephony, video gaming, etc.), for example, may be optimized and/or the bandwidth (BW) consumption may be reduced, for example, for the IEEE 802.11 standards (e.g., WiFi related applications). One or more modes of WiFi, such as Enhanced Distributed Channel Access (EDCA), Hybrid Coordination Function (HCF) Controlled Channel Access (HCCA), and/or Distributed Content Function (DCF) (e.g., DCF only MAC), for example, may be enhanced. An importance level may be associated with (e.g., attached to) a video packet at the video source, for example for each mode. An importance level may be determined (e.g., dynamically determined), for example, based on the history of packet loss incurred for the flow of the video stream. Video packets of a video application may be broken down into sub-classes based on importance level. An importance level may be determined, for example, dynamically determined, for a video packet by a station (STA) or access point (AP), for example, for each mode. An AP may refer to a WiFi AP, for example. A STA may refer to a wireless transmit/receive unit (WTRU) or a wired communication device, such as a personal computer (PC), server, or other device that may not be an AP.

A reduction of QoE prediction to peak signal-to-noise ratio (PSNR) time series prediction may be provided herein. A per-frame PSNR prediction model may be described that may be jointly implemented by the video sender (e.g., microcontroller, smart phone, etc.) and the communication network.

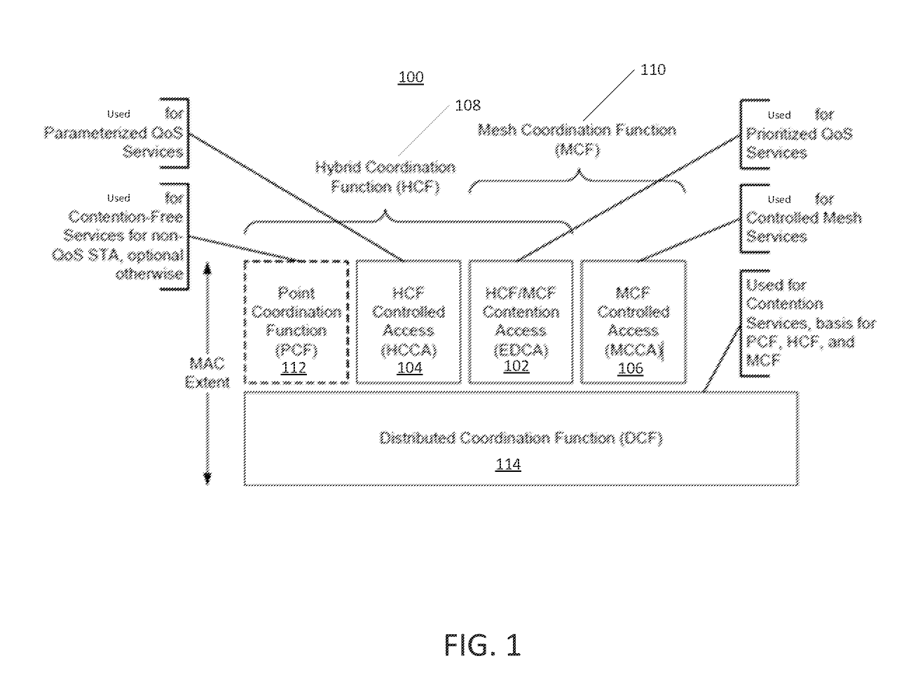

One or more enhancements to the media access control (MAC) layer may be provided herein. FIG. 1 is a diagram illustrating an example MAC architecture 100. The MAC architecture 100 may comprise one or more functions, such as Enhanced Distributed Channel Access (EDCA) 102, HCF Controlled Channel Access (HCCA) 104, MCF Controlled Channel Access (MCCA) 106, Hybrid Coordination Function (HCF) 108, Mesh Coordination Function (MCF) 110, Point Coordination Function (PCF) 112, Distributed Coordination Function (DCF) 114, etc.

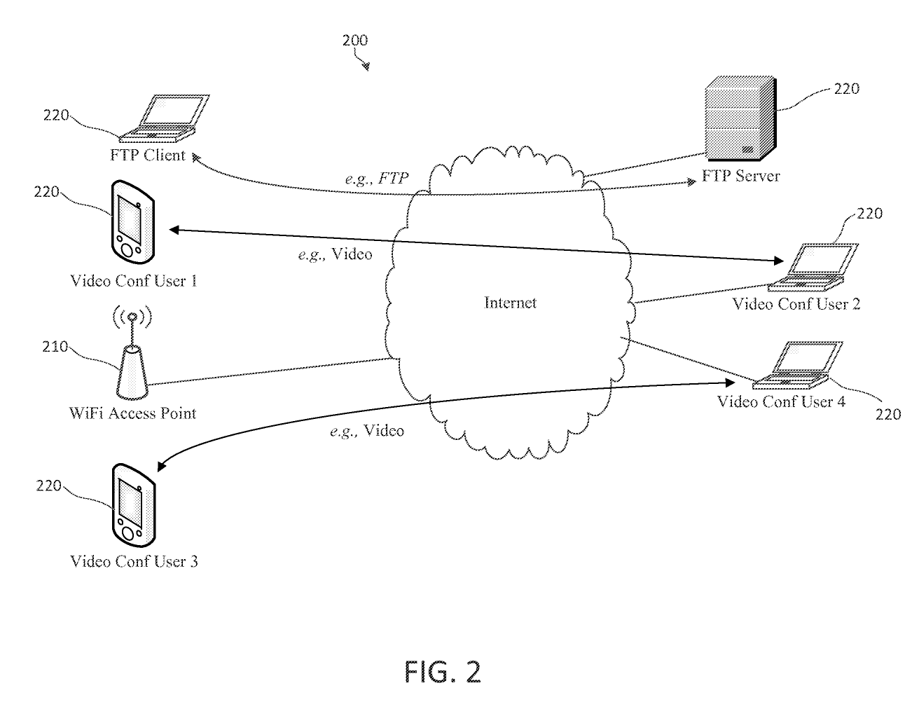

FIG. 2 is a diagram illustrating an example of a system 200. The system 200 may comprise one or more APs 210 and one or more STAs 220, for example, that may carry real-time video traffic (e.g., video telephony traffic, video gaming traffic, etc.). Some applications may serve as cross traffic.

A static approach may be utilized to prioritize the transmission of a packet in a video application (e.g., a real-time video application). In the static approach, the importance of a video packet may be determined by the video source (e.g., the video sender). The importance of the video packet may remain the same during the transmission of this packet across the network.

A dynamic approach may be utilized to prioritize the transmission of a packet in a video application (e.g., a real-time video application). In the dynamic approach, the importance of a video packet may be determined dynamically by the network, for example, after the video packet leaves the source and before the video packet arrives at its destination. The importance of the video packet may be based on what has happened to past video packets in the network and/or what may be predicted to happen to future video packets in the network.

Although described with reference to video telephony, the techniques described herein may be utilized with any real-time video applications, such as video gaming, for example.

Enhancements to EDCA may be provided. In EDCA, four access categories (ACs) may be defined: AC_BK (e.g., for background traffic), AC_BE (e.g., for best effort traffic), AC_VI (e.g., for video traffic), and AC_VO (e.g., for voice traffic). One or more parameters may be defined, such as but not limited to, contention window (CW), Arbitration Inter-Frame Spacing (AIFS) (e.g., as determined by setting the AIFS number (AIFSN)), and/or transmit opportunity (TXOP) limit. A quality of service (QoS) differentiation may be achieved by assigning each AC a different set of values for the CW, the AIFS, and/or the TXOP limit.

The ACs (e.g., AC_BK, AC_BE, AC_VI, AC_VO) may be referred to as classes. Video packets of the AC_VI may be broken down into sub-classes based on importance level. One or more parameters (e.g., contention window, AIFS, TXOP limit, retransmission limit, etc.) may be defined for each importance level (e.g., sub-class) of video packets. A quality of service (QoS) differentiation may be achieved within the AC_VI of a video application, for example, by utilizing an importance level.

Table 1 illustrates example settings for the CW, the AIFS, and the TXOP limit for each of the four ACs described above when a dot11OCBActivated parameter has a value of false. When the dot11OCBActivated parameter has a value of false, then a network (e.g., a WiFi network) operation may be in a normal mode, for example, a STA may join a basic service set (BSS) and send data. A network (e.g., a WiFi network) may be configured with parameters that may be different from the values represented in Table 1, for example, based on the traffic condition and/or the QoS requests of the network.

TABLE 1
Example of EDCA Parameter Set Element Parameter Values

| | | | | TXOP Limit | | |
|---|---|---|---|---|---|---|
| | | | | | For PHYs | |
| | | | | For PHYs | defined in | |
| | | | | defined in | Clause 18, | |
| | | | | Clause 16 | Clause 19, | |
| | | | | and | and Clause | Other |
| AC | CWmin | CWmax | AIFSN | Clause 17 | 20 | PHYs |
| AC_BK | aCWmin | aCWmax | 7 | 0 | 0 | 0 |
| AC_BE | aCWmin | aCWmax | 3 | 0 | 0 | 0 |
| AC_VI | (aCWmin + 1)/2-1 | aCWmin | 2 | 6.016 ms | 3.008 ms | 0 |
| AC_VO | (aCWmin + 1)/4-1 | (aCWmin + 1)/2-1 | 2 | 3.264 ms | 1.504 ms | 0 |

Video traffic may be treated differently from other types of traffic (e.g., voice traffic, best effort traffic, background traffic, etc.), for example, in the 802.11 standard. For example, the access category of a packet may determine how that packet is transmitted with respect to packets of other access categories. For example, the AC of a packet may represent a transmission priority of the packet. For example, voice traffic (AC_VO) may be transmitted with the highest priority of the ACs. However, there may not be any differentiation between types of video traffic within the AC_VI, for example, in the 802.11 standard. The impact of losing a video packet on the quality of the recovered video may be different from packet to packet, for example, as not every video packet may be equally important. Video traffic may be further differentiated. The compatibility of video traffic with other traffic classes (e.g., AC_BK, AC_BE, AC_VO) and video streaming traffic may be considered. When video traffic is further differentiated in sub-classes, the performance of other ACs may remain unchanged.

One or more Enhanced Distributed Channel Access Functions (EDCAFs) may be created for video traffic, e.g., video telephony traffic. The one or more EDCAFs may refer to a quantization of the QoS metric space with the video AC. One or more EDCAFs may reduce or minimize the control overhead while being able to provide enough levels of differentiation within video traffic.

A static approach may be utilized to prioritize the transmission of a packet in a video application (e.g., a real-time video application). In the static approach, the importance of a video packet may be determined by the video source. The importance of the video packet may change during the transmission of this packet across the network. Static prioritization of the video packet may be performed at the source. The priority level may change during the transmission of the video packet, for example, based on history of packet loss that incurs to this flow. For example, a packet that was deemed the highest importance by the video source may be downgraded to a lower level of importance because of packet loss occurrence to that flow.

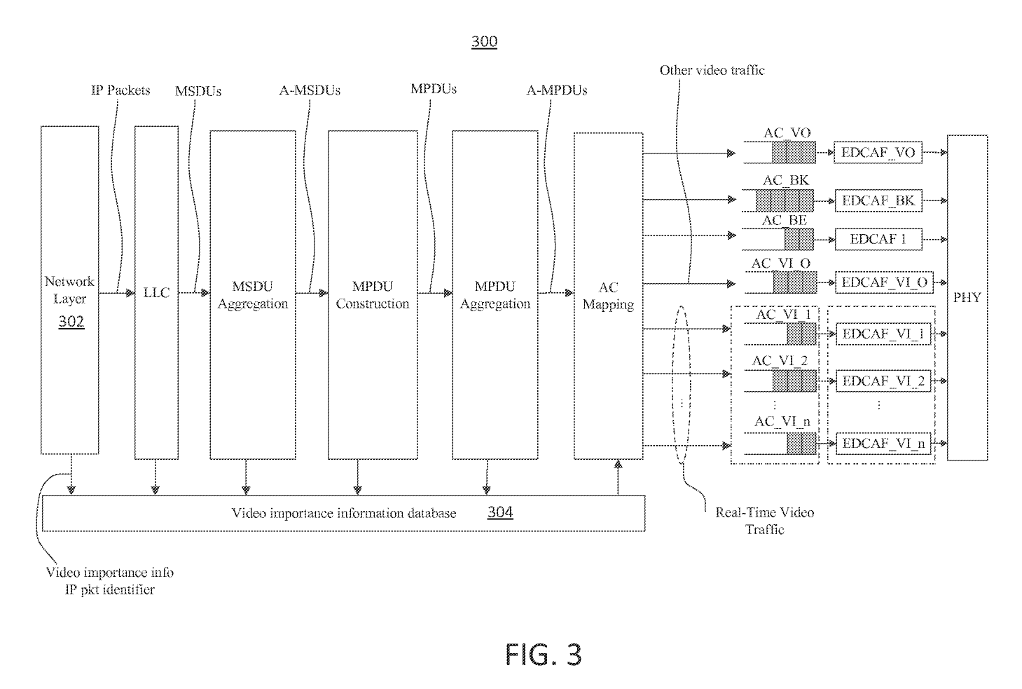

FIG. 3 is a diagram illustrating an example system architecture 300 for an example static prioritization approach for EDCA. A network layer 302 may pass packet importance information to a video importance information database 304. The packet importance information may provide a level of importance for different types of video packets. For example, in the case of Hierarchical P, the temporal layer 0 packets may be more important than temporal layer 1 packets, and temporal layer 1 packets may be more important than temporal layer 2 packets, and so on.

The video traffic may be separated into two classes, e.g., real-time video traffic and other video traffic, for example by the AC mapping function. The other video traffic may be referred to as AC_VI_O. The AC_VI_O may be served to the physical layer (PHY) to be transmitted in a manner that video traffic is served according to the AC for video. The mapping of the packets (e.g., IP packets) and the Aggregated MPDUs (A-MPDUs) may be performed utilizing a table lookup.

The real-time video traffic may be differentiated utilizing the importance information of the packet, for example, the Hierarchical P categorization described herein. For example, packets belonging to temporal layer 0 may be characterized by importance level 0, packets belonging to temporal level 1 may be characterized by importance level 1, and packets belonging to temporal layer 2 may be characterized by importance level 2.

The contention window may be defined based on importance level. The range of the contention window for video (CW[AC_VI[), which may be denoted as [CWmin(AC_VI), CWmax(AC_VI)], may be partitioned, for example, into smaller intervals, for example, for compatibility. CW(AC_VI) may grow exponentially with the number of failed attempts to transmit a MPDU, e.g., starting from CWmin(AC_VI) and topping at CWmax(AC_VI). A backoff timer may be drawn at random, e.g., uniformly from the interval [0, CW(AV_VI)]. A backoff timer may be triggered after the medium remains idle for an AIFS amount of time, and it may specify thereafter how long a STA or an AP may be silent before accessing the medium.

AC_VI_1, AC_VI_2, . . . , AC_VI_n may be defined. The video traffic carried by AC_VI_i may be more important than the video traffic carried by AC_V_j for i<j. The interval [CWmin(AC_VI), CWmax(AC_VI)] may be partitioned into n intervals, for example, which may or may not have equal lengths. For example, if the intervals have equal lengths, then, for AC_VI_i, its CW(AC_VI_i) may take values from the interval according to rules, such as exponentially increasing with the number of failed attempts to transmit an MPDU

[ceiling(CWmin(AC_VI)+(i−1)*d), floor(CWmin(ACVI)+i*d)]

where ceiling( ) may be the ceiling function, and floor( ) may be the floor function, and d=(CWmax(AC_VI)−CWmin(AC_VI))/n.

Partitioning the range of the contention window for video in such a manner may satisfy the compatibility requirement when the amounts of traffic for different video telephony traffic types are equal. The distribution of the backoff timer for video traffic as a whole may be kept close to that without partitioning.

The interval [CWmin(AC_VI), CWmax(AC_VI)] may be partitioned unequally. For example, if the amount of traffic of different types of video traffic may not be equal. The interval [CWmin(AC_VI), CWmax(AC_VI)] may be partitioned unequally such that the small intervals resulting from the partition may be proportional (e.g., per a linear scaling function) to an amount of traffic of a traffic class (e.g., the respective amounts of traffic of each traffic class). The traffic amounts may be monitored and/or may be estimated by a STA and/or an AP.

Arbitration inter-frame spacing (AIFS) may be defined based on importance level. For example, AIFS numbers (AIFSNs) for an AC that has a priority higher than AC_VI and for an AC that has a priority lower than AC_VI may be AIFSN1 and AIFSN2, respectively. For example, in Table 1, AIFSN2=AIFSN(AC_BE), and AIFSN1=AIFSN(AC_VO).

n numbers may be selected for AIFSN(AC_VI_i), i=1, 2, . . . , n, from the interval [AIFSN1, AIFSN2], each for a type of video telephony traffic, such that AIFSN(AC_VI_1)≦AIFSN(AC_VI_2)≦ . . . ≦AIFSN(AC_VI_n). The differentiation between video traffic as a whole and other traffic classes may be preserved. For example, if a video stream may keep accessing the medium in the case where video traffic may be serviced as a whole, then when different types of video packets are differentiated on the basis of importance level, a video flow may continue to access the medium with a similar probability.

One or more constraints may be imposed. For example, the average of these n selected numbers may be equal to the AIFSN(AC_VI) used in the case where differentiation within video traffic on the basis of importance is not performed.

The transmit opportunity (TXOP) limit may be defined based on importance level. The setting for TXOP limit may be PHY specific. The TXOP limit for an access category and a given type of PHY (called PHY_Type) may be denoted as TXOP_Limit(PHY_Type, AC). Table 1 illustrates examples of three types of PHYs, for example, the PHYs defined in Clause 16 and Clause 17 (e.g., DSSS and HR/DSSS), the PHYs defined in Clause 18, Clause 19, and Clause 20 (e.g., OFDM PHY, ERP, HT PHY), and other PHYs. For example, PHY_Type may be 1, 2, and 3, respectively. For example, TXOP_Limit(1, AC_VI)=6.016 ms, which may be for the PHYs defined in Clause 16 and Clause 17.

A maximum possible TXOP limit may be TXOPmax. n numbers for TXOP_Limit(PHY_Type, AC_VI_i) may be defined, for example, i=1, 2, . . . , n, from an interval around TXOP_Limit(PHY_Type, AC_VI), each for a type of video packets. Criteria may be imposed on these numbers. For example, the average of these numbers may be equal to TXOP_Limit(PHY_Type, AC_VI), for example, for compatibility.

Retransmission limits may be associated with an importance level. The 802.11 standard may define two attributes, e.g., dot11LongRetryLimit and dot11ShortRetryLimit, to set the limit on the number of retransmission attempts, which may be the same for the EDCAFs. The attributes, dot11LongRetryLimit and dot11ShortRetryLimit, may be dependent on the importance information (e.g., priority) of the video traffic.

For example, values dot11LongRetryLimit=7 and dot11ShortRetryLimit=4 may be utilized. The values may be defined for each importance level (e.g., priority) of video traffic, for example, dot11LongRetryLimit(AC_VU) and dot11ShortRetryLimit(AC_VU), i=1, 2, . . . , n. Higher-priority packets (e.g., based on importance information) may be afforded more potential retransmissions, and lower-priority packets may be given fewer retransmissions. The retransmission limits may be designed such that the average number of potential retransmissions may remain the same as that for AC_VI_O, for example, for a given distribution of the amounts of traffic from video packets with different priorities. The distribution may be monitored and/or updated by an AP and/or a STA. For example, a state variable amountTraffic(AC_VI_i) may be maintained for each video traffic sub-class (e.g., importance level), for example, to keep a record on the amount of traffic for that sub-class. The variable amountTraffic(AC_VI_i) may be updated as follows: amountTraffic(AC_VI_i)←a*amountTraffic(AC_VI_i)+(1−a)*(the number of frames in AC_VI_i arrived in the last time interval of duration T), where time may be partitioned into time intervals of duration T, and 0<a<1 may be a constant weight.

The fraction of traffic belonging to AC_VI _i may be:

$${p}_{i} = \frac{amountTraffic ( AC\_VI \_i )}{{\sum }_{j = 1}^{n} amountTraffic ( AC\_VI \_j )} , \qquad ( 1 )$$

where i=1, 2, . . . , n.

For example, dot11LongRetryLimit(AC_VI_i)=floor((n−i+1)L), for i=1, 2, . . . , n. L may be solved, for example, to make the average equal to dot11LongRetryLimit(AC_VI_O).

Σᵢ₌₁ⁿpᵢfloor((n−i+1)L)=dot11LongRetryLimit(AC_VI_O) (2)

which may provide an approximate solution:

$$L = \frac{dot 11 LongRetryLimit ( AC\_VI \_O )}{{\sum }_{j = 1}^{n} {p}_{i} ( n - i + 1 )} \qquad ( 3 )$$

which may provide the value for dot11LongRetryLimit(AC_VI_i) according to dot11LongRetryLimit(AC_VI_i)=floor((n−i+1)L), for i=1, 2, . . . , n.

Similarly, the value of dot11ShortRetryLimit(AC_VI_i) may be determined as:

$$dot 11 ShortRetryLimit ( AC\_VI \_i ) = floor ( ( n - i + 1 ) \frac{dotShortRetryLimit ( AC\_VI \_O )}{{\sum }_{i = 1}^{n} {p}_{i} ( n - i + 1 )} ) \qquad ( 4 )$$

where i=1, 2, . . . , n. The procedure may be implemented by an AP and/or a STA, for example, independently. Changing (e.g., dynamically changing) the values of these limits may not incur communication overhead, for example, because the limits may be transmitter driven.

The choice of the retransmission limits may be based on the level of contention experienced, for example, by the 802.11 link. The contention may be detected in various ways. For example, the average contention window size may be an indicator of contention. The Carrier Sense Multiple Aggregation (CSMA) result (e.g., whether the channel is free or not) may be an indicator of contention. If rate adaptation is used, then the average number of times that an AP and/or a STA gives up a transmission after reaching the retry limit may be used as an indicator of contention.

A dynamic approach may be utilized to prioritize the transmission of a packet in a video application (e.g., a real-time video application). In the dynamic approach, the importance of a video packet may be determined dynamically by the network, for example, after the video packet leaves the source and before the video packet arrives at its destination. The importance of the video packet may be based on what has happened to past video packets in the network and/or what is predicted to happen to future video packets in the network.

The prioritization of a packet may be dynamic. The prioritization of a packet may depend on what has happened to previous packets (e.g., a previous packet gets dropped) and the implications of failing to deliver this packet to future packets. For example, for video telephony traffic, the loss of a packet may result in error propagation.

There may be two traffic directions, for example, at the media access control (MAC) layer. One traffic direction may be from an AP to a STA (e.g., downlink), and the other traffic direction may be from a STA to an AP (e.g., uplink). In the downlink, the AP may be a central point, where prioritization over different video telephony traffic flows destined to different STAs may be performed. The AP may compete for medium access with the STAs sending uplink traffic, for example, due to the TDD nature of the WiFi channel and the CSMA type of medium access. A STA may originate multiple video traffic flows, and one or more of the traffic flows may go in the uplink.

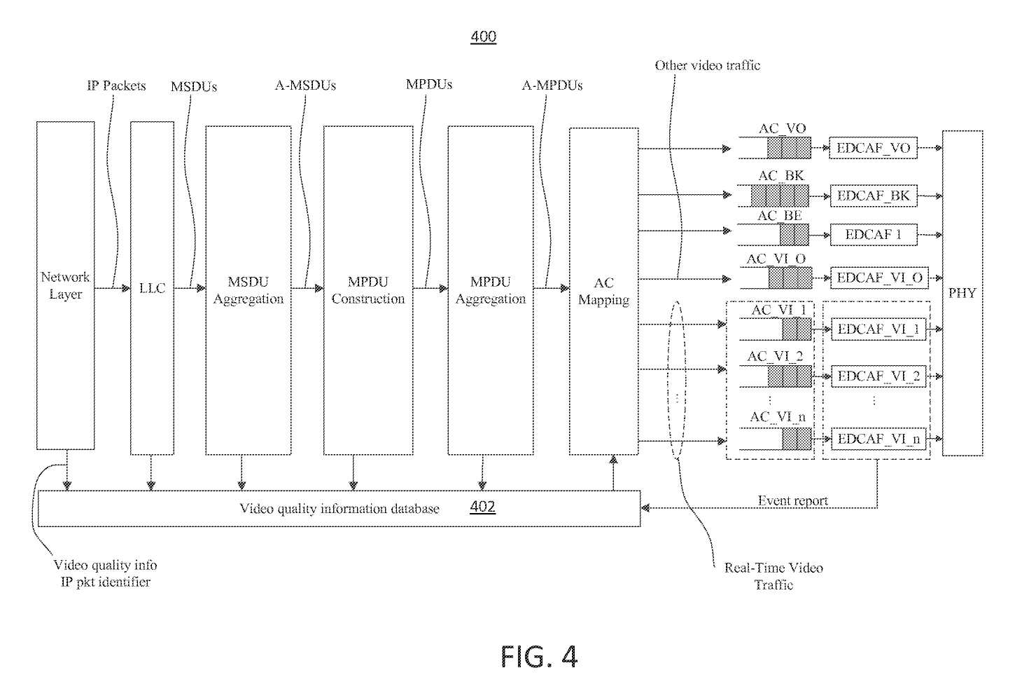

FIG. 4 is a diagram illustrating an example system architecture 400 for an example dynamic video traffic prioritization approach for EDCA. The video quality information may be or include parameters that may indicate the video quality degradation if the packet gets lost. In AC mapping, the video telephony traffic may be separated into multiple classes (e.g., dynamically) based on the video quality information (e.g., from a video quality information database 402) for the packets under consideration and/or the events that have happened at the MAC layer (e.g., as reported by the EDCAF_VI_i modules, i=1, 2, . . . , n). An event report may comprise the A-MPDU sequence control number and/or the result of the transmission of this A-MPDU (e.g., success or failure).

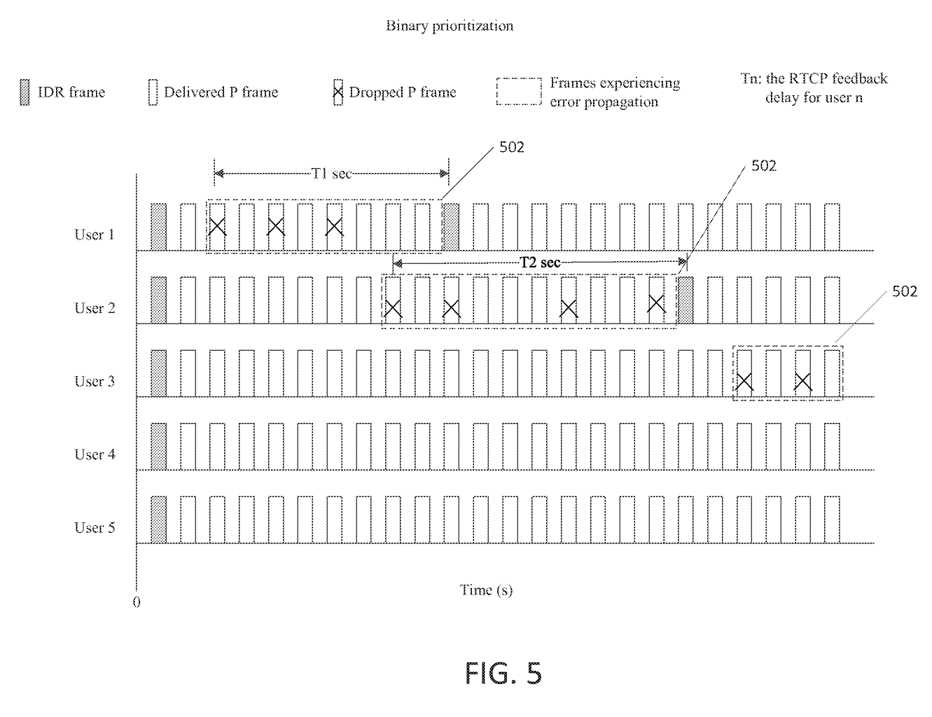

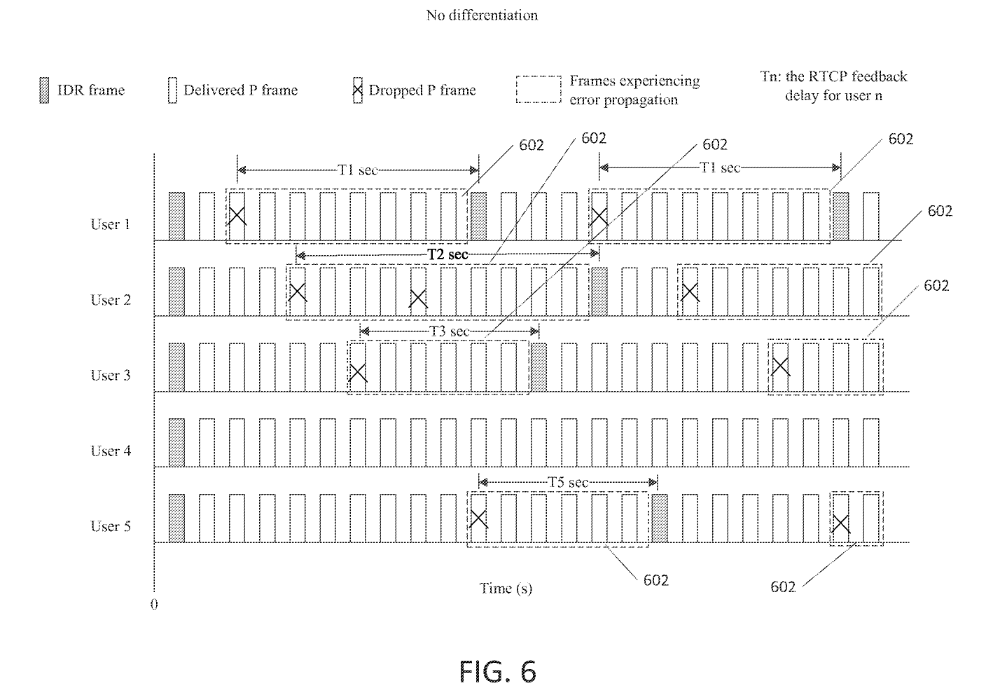

A binary prioritization, three-level dynamic prioritization, and/or expected video quality prioritization may be utilized. FIG. 5 is a diagram illustrating an example of binary prioritization. FIG. 6 is a diagram illustrating an example of no differentiation. In binary prioritization, if multiple video telephony traffic flows traverse an AP, the AP may identify a flow that has suffered from packet losses and may assign a lower priority to that flow. The dashed boxes 502, 602 of FIG. 5 and FIG. 6 indicate the extent of error propagation.

Binary prioritization may be a departure from video-aware queue management in that a router in video-aware queue management may drop packets, while the AP (or STA) utilizing binary prioritization may lower the priority of certain packets (e.g., which may not necessarily lead to packet losses). The video-aware queue management may be a network layer solution, and it may be used in conjunction with the binary prioritization at layer 2, for example as described herein.

Three-level dynamic prioritization may improve the QoE of the real-time video without negatively affecting cross traffic.

In some real-time video applications, such as video teleconferencing, an IPPP video encoding structure may be used to satisfy delay constraints. In an IPPP video encoding structure, the first frame of the video sequence may be intra-coded, and the other frames may be encoded using a preceding (e.g., the immediately preceding) frame as the reference for motion compensated prediction. When transmitted in a lossy channel, a packet loss may affect the corresponding frame and/or subsequent frames, e.g., errors may be propagated. To deal with packet losses, macroblock (MB) intra refresh may be used, e.g., some MBs of a frame may be intra-coded. This may alleviate error propagation, e.g., at the expense of lower coding efficiency.

The video destination may feed back the packet loss information to the video encoder to trigger the insertion of an Instantaneous Decoder Refresh (IDR) frame, which may be intra-coded, so that subsequent frames may be free of error propagation. The packet loss information may be sent via an RTP control protocol (RTCP) packet. When the receiver detects a packet loss, it may send back the packet loss information, which may include the index of the frame to which the lost packet belongs. After receiving this information, the video encoder may decide whether the packet loss creates a new error propagation interval. If the index of the frame to which the lost packet belongs is less than the index of the last IDR frame, the video encoder may do nothing. The packet loss may occur during an existing error propagation interval, and a new IDR frame may have already been generated, which may stop the error propagation. Otherwise, the packet loss may create a new error propagation interval, and the video encoder may encode the current frame in the intra mode to stop the error propagation. The duration of error propagation may depend on the feedback delay, which may be at least the round trip time (RTT) between the video encoder and decoder. Error propagation may be alleviated using recurring IDR frame insertion, in which a frame may be intra-coded after every (e.g., fixed) number of P frames.

In IEEE 802.11 MAC, when a transmission is not successful, a retransmission may be performed, for example, until a retry limit or retransmission limit is exceeded. The retry limit or retransmission limit may be a maximum number of transmission attempts for a packet. A packet that could not be transmitted after the maximum number of transmission attempts may be discarded by the MAC. A short retry limit or retransmission limit may apply for packets with a packet length less than or equal to a Request to Send/Clear to Send (RTS/CTS) threshold. A long retry limit or retransmission limit may apply for packets with a packet length greater than the RTS/CTS threshold. The use of RTS/CTS may be disabled, and the short retry limit or retransmission limit may be used and may be denoted by R.

MAC layer optimization may improve video quality by providing differentiated service to video packets, for example, by adjusting the transmission retry limit and may be compatible with other stations in the same network. A retry limit may be assigned according to the importance of a video packet. For example, a low retry limit may be assigned to less important video packets. More important video packets may gain more transmission attempts.

A retry limit may be dynamically assigned to a video packet based on the type of video frame that a packet carries and/or the loss events that have happened in the network. Some video packet prioritization may involve static packet differentiation. For example, video packet prioritization may depend on the video encoding structure, e.g., recurring IDR frame insertion and/or scalable video coding (SVC). SVC may separate video packets into substreams based on the layer to which a video packet belongs and may notify the network of the respective priorities of the substreams. The network may allocate more resources to the substreams with higher priorities, for example, in the event of network congestion or poor channel conditions. Prioritization based on SVC may be static, e.g., it may not consider instantaneous network conditions.

An analytic model may evaluate the performance of MAC layer optimization, e.g., the impact on video quality. Considering the transmission of cross traffic, a compatibility condition may prevent MAC layer optimization from negatively affecting cross traffic. Simulations may show that the throughput of cross traffic may remain substantially similar to a scenario in which MAC layer optimization is not employed.

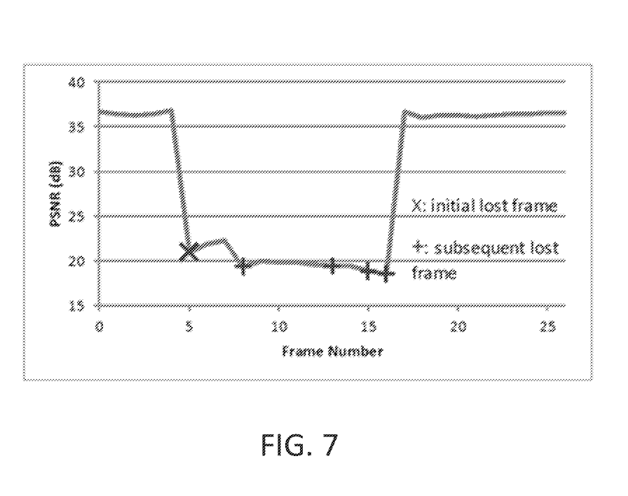

Retry limits may be the same for packets, e.g., all packets. FIG. 7 illustrates an example of PSNR as a function of frame number. As illustrated in FIG. 7, because of the loss of frame 5, subsequent P frames may become erroneous until the next IDR frame, and video quality may remain low regardless of whether subsequent frames are received successfully. The transmission of these frames may be less important to the video quality, and the retry limit may be lowered for them.

Video frames may be classified into a number of priority categories, e.g., three priority categories, and a retry limit R may be assigned for the video frames with priority i (i=1,2,3), where priority 1 may be the highest priority and R₁>R₂=R>R₃. An IDR frame and the frames after the IDR frame may be assigned a retry limit R₁ until a frame is lost or a compatibility criterion is not satisfied. After generating an IDR frame, the decoded video sequence at the receiver may be error-free as long as possible. If the network drops a frame shortly after the IDR frame, the video quality may decrease dramatically and may remain poor until a new IDR frame is generated, which may take at least 1 RTT. The benefit of an IDR frame that is quickly followed by packet loss may be limited to a few video frames. The IDR frames and the frames subsequent to the IDR frames may be prioritized. When the MAC layer discards a packet because of the retry limit is reached, the subsequent frames may be assigned the smallest retry limit R₃, until a new IDR frame is generated, because a higher retry limit may not improve the video quality. Other frames may be assigned a retry limit R₂.

A compatibility criterion may be applied such that the performance of other access categories (ACs) is not negatively affected by configuring (e.g., optimizing) the retry limits for the video packets. The total number of transmission attempts of a video sequence may be maintained the same with or without configuring (e.g., optimizing) retry limits.

The average number of transmission attempts for the video packets may be determined by monitoring the actual number of transmission attempts. The average number of transmission attempts for the video packets may be estimated. For example, p may represent the collision probability of a single transmission attempt at the MAC layer of the video sender. p may be a constant and may be independent for the packets, regardless of the number of retransmissions. The transmission queue of a station may not be empty. The probability p may be monitored at the MAC layer and may be used as an approximation of collision probability, e.g., when the IEEE 802.11 standard is used. The probability that a transmission still fails after r attempts may be p^{r}. For a packet with retry limit R, the average number of transmission attempts may be given by

$${\sum }_{i = 1}^{R} i \cdot {p}^{i - 1} ( 1 - p ) + R \cdot {p}^{R} = \frac{1 - {p}^{R}}{1 - p} , \qquad ( 5 )$$

where pⁱ⁻¹(1−p) may be the probability that a packet is successfully transmitted after i attempts, and p^{R} in the second term on the left hand side of Equation (5) may be the probability that the transmission still fails after R attempts. For convenience, let p₀=p^{R} and pᵢ=p^{R}^{ᵢ} for i=1,2,3, where pᵢ is the packet loss rate when the retry limit is Rᵢ. Since R₁>R₂=R>R₃, p₁<p₂=p₀<p₃. M may be the total size (e.g., in bytes) of data in the video sequence, and M (i=1,2,3) may be the total size of data of video frames with retry limit Rᵢ, where M=M₁+M₂+M₃. To satisfy the compatibility criterion, the total number of transmission attempts may not increase after the packet retry limits are increased, e.g.,

$$\frac{1 - {p}_{0}}{1 - p} M \geq {\sum }_{i = 1}^{3} \frac{1 - {p}_{i}}{1 - p} {M}_{i} . \qquad ( 6 )$$

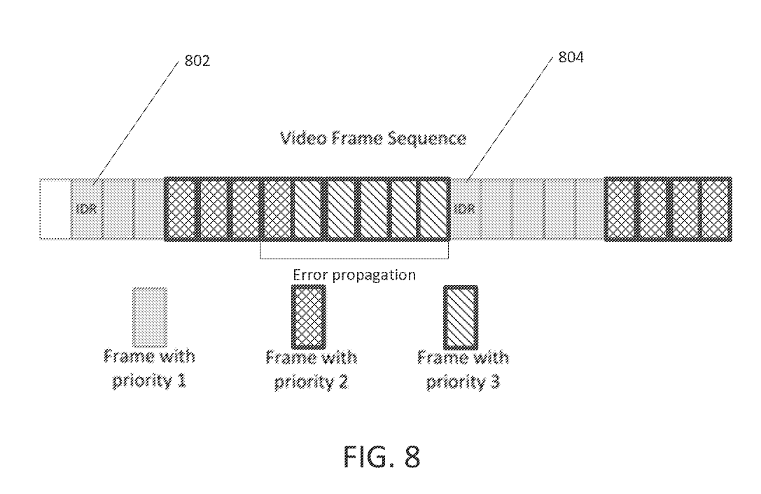

Three-level dynamic prioritization may be performed. A frame may be assigned a priority level based, for example, on its type. The priority level may be assigned based on the successful transmission or failure to transmit a packet or packets, e.g., an adjacent packet or packets. The priority level may be based in part on whether a compatibility criterion is satisfied. FIG. 8 illustrates an example of three-level dynamic prioritization. IDR frames 802, 804 may be assigned priority 1. For a subsequent frame, if its preceding frames are successfully transmitted, it may be assigned priority 1 if a compatibility criterion is satisfied. If the compatibility criterion is not satisfied for a frame, the MAC may assign priority 2 to that frame as well as the subsequent frames until a packet is dropped due to exceeding the retry limit. When a packet with priority 1 or 2 is dropped, one or more subsequent frames may be assigned priority 3, for example, until the next IDR frame. The number of consecutive frames with priority 3 may be determined by the duration of error propagation, which may be at least one RTT. The accumulative sizes M and Mᵢ may be calculated from the beginning of the video sequence. When the video duration is large, the accumulative size may be updated, for example, during a certain time period or for a certain number of frames.

Accumulative packet sizes M and M₀ may be initialized to values of 0. Priorities of the current frame and the last frame, q and q₀ respectively, may be initialized to values of 0. When a video frame with size m arrives from the higher layer, its priority q may be set to 1 if it is an IDR frame. Otherwise, if the priority q₀ of the last frame is 3, the priority q of the current frame may be set to 3. If the last frame is dropped when the current frame is not an IDR frame and the priority q₀ of the last frame is not 3, the priority q of the current frame may be set to 3. If the priority q₀ of the last frame is 2 when the current frame is not an IDR frame and the last frame is not dropped, the priority q of the current frame may be set to 2. If inequality (6) is satisfied when the current frame is not an IDR frame and the last frame is not dropped and the priority qo of the last frame is 1, the priority q of the current frame may be set to 1. If none of these conditions applies, the priority q of the current frame may be set to 2. The priority q₀ of the last frame may then be set to the priority q of the current frame. The accumulative packet sizes M and M_{q} may both be increased by the size m of the video frame. This process may repeat, for example, until the video session ends.

A frame may be assigned priority 2 when the last frame was assigned priority 2 or inequality (6) is not satisfied. If inequality (6) is satisfied, no frame may be assigned priority 2, e.g., frames may be assigned priority 1 or 3.

Some video teleconferencing applications may present the most recent error-free frame rather than present erroneous frames. The video destination may freeze the video during error propagation. The freeze time may be the metric for performance evaluation. For a constant frame rate, the freeze time may be an equivalent metric to the number of frozen frames due to packet losses.

IDR and non-IDR video frames may be encoded into d and d′ packets with the same size, respectively, where d>d′. N may be the total number of frames encoded thus far, and n may be the number of packets, when the IEEE 802.11 standard is used. As disclosed herein, a priority may be assigned to a frame. The number of packets with priority i may be denoted by nᵢ·n and n₁+n₂+n₃ may be different because there may be different numbers of IDR frames in these scenarios. N may be large enough, and it may be assumed that n, n₁, n₂, n₃>0. By assuming that the packets have the same size, the inequality (6) can be rewritten as

$$\frac{1 - {p}_{0}}{1 - p} n \geq {\sum }_{i = 1}^{3} \frac{1 - {p}_{i}}{1 - p} {n}_{i} . \qquad ( 7 )$$

Considering a constant frame rate, D may be the number of frames sent during a feedback delay. When a packet is lost in transmission, the packet loss information may be received at the video source a feedback delay after the packet was sent. A new IDR frame may be generated, e g., immediately, which may be the D^{th} frame after the frame to which the lost packet may belong. D−1 frozen frames may be affected by error propagation. For example, if the feedback delay is short, at least the frame(s) to which the lost packet belongs may be erroneous. It may be assumed that D≧1, and the interval containing the D frozen frames may be a frozen interval.

The packet loss probability p₀ may be so small that in a frozen interval, there may be one packet loss (e.g., the first packet), when the IEEE 802.11 standard is used. The number of independent error propagations may be equal to the number of lost packets, which may be p₀n in an n-packet video sequence. The expected total number of erroneous frames, e.g., frozen frames, may be given by

N_{f}=p₀nD. (8)

As disclosed herein, a frozen interval may begin with an erroneous frame with priority 1 or 2, which may be followed by D−1 frames with priority 3. The numbers of lost packets with priority 1 and 2 may be p₁n₁ and p₂n₂, respectively. The total number of frozen frames may be

N′_{f}=(p₁n₁+p₂n₂)D. (9)

The frames with priority 3 may appear in frozen intervals, and one or more frames (e.g., each frame) may be encoded into d′ packets. The expected total number of packets with priority 3 may be given by

$${n}_{3} = \frac{D - 1}{D} {N}_{f}^{′} {d}^{′} . \qquad ( 10 )$$

When D=1, one frame (e.g., the frame to which the lost packet belongs) may be transmitted in the frozen interval, and the next frame may be an IDR frame that may stop the frozen interval. No frame may be assigned priority 3, and n₃=0.

n′₁ may be the number of packets that belong to IDR frames. Except for the first IDR frame, other IDR frames may appear after the ends of frozen intervals, and IDR frames may be encoded into d packets. The total number of packets belonging to IDR frames may be given by

$${n}_{1}^{′} = ( \frac{{N}_{f}^{′}}{D} + 1 ) d \qquad ( 11 )$$

Using the IEEE 802.11 standard, a lost packet may trigger a new IDR frame. The first frame of the video sequence may be an IDR frame, so the expected total number of the IDR frames is p₀n+1. The expected total number of packets may be given as

n=(p₀n+1)d+[N−(p₀n+1)]d′.

We can solve N from the above equation as

$$N = \frac{n - ( {p}_{0} n + 1 ) ( d - {d}^{′} )}{{d}^{′}} . \qquad ( 12 )$$

As disclosed herein, a lost packet with priority 1 or 2 may cause the generation of a new IDR frame. The expected total number of packets may be given as

n₁+n₂+n₃=(p₁n₁+p₂n₂+1)d+[N−(p₁n₁+p₂n₂+1)]d′.

The total number of frames can be solved from the above equation as

$$N = \frac{( {n}_{1} + {n}_{2} + {n}_{3} ) - ( {p}_{1} {n}_{1} + {p}_{2} {n}_{2} + 1 ) ( d - {d}^{′} )}{{d}^{′}} . \qquad ( 13 )$$

A quantity Δd may be defined as Δd=d−d′. From (12) and (13),

n−(p₀n+1)Δd=(n₁+n₂+n₃)−(p₁n₁+p₂n₂+1)Δd. (14)

Because p₂=p₀,

(1−p₀Δd)(n−n₂)=(1−p₁Δd)n₁+n₃>(1−p₁Δd)(n₁+n₃). (15)

The above inequality follows from the fact that 1−p₁Δd<1, and the equality holds when n₃=0, e.g., if D=1. Because p₁<p₀, 1−p₀Δd<1−p₁Δd. It follows from (15) that

$$n - {n}_{2} > \frac{1 - {p}_{1} Δ d}{1 - {p}_{0} Δ d} ( {n}_{1} + {n}_{3} ) > {n}_{1} + {n}_{3} . \qquad ( 16 )$$

From the above inequality, n>n₁+n₂+n₃, e.g., for the same video sequence, the number of packets when the IEEE 802.11 standard is used may be greater than that when QoE-based optimization is used.

N_{I} and N′_{I} may denote the number of IDR frames when the IEEE 802.11 standard and QoE-based optimization is used, respectively. IDR frames and non-IDR frames may be encoded into d and d′ packets, respectively, the total numbers of packets when the IEEE 802.11 standard is used may be given by

$$\begin{matrix}n = {dN}_{I} + {d}^{′} ( N - {N}_{I} ) \\ = {d}^{′} N + Δ {dN}_{I} .\end{matrix}$$

When QoE-based optimization is used, the total number of packets may be

n₁+n₂+n₃=d′N+ΔdN′_{I}.

Since n>n₁+n₂+n₃, from the above two equations, N_{I}>N′_{I}. A frozen interval may trigger the generation of an IDR frame, and except the first IDR frame, which may be the first frame of the video sequence, IDR frame may appear immediately after a frozen interval. Then,

N_{f}=(N_{I}−1)D

N′_{f}=(N′_{I}−1)D.

The number of frozen frames when QoE-based optimization is used may be smaller than that when the IEEE 802.11 standard is used, e.g.,

N′_{f}<N_{f} (17)

### From (14),

n−(n₁+n₂+n₃)=[p₀n−(p₁n₁+p₂n₂)]Δd. (18)

Because the left hand side of (18) is greater than 0, p₀n−(p₁n₁+p₂n₂)>0. Considering the compatibility criterion (7),

$$\frac{1 - {p}_{0}}{1 - p} n - {\sum }_{i = 1}^{3} \frac{1 - {p}_{i}}{1 - p} {n}_{i} = \frac{n - ( {n}_{1} + {n}_{2} + {n}_{3} ) - {p}_{0} n + ( {p}_{1} {n}_{1} + {p}_{2} {n}_{2} + {p}_{3} {n}_{3} )}{1 - p} = \frac{[ {p}_{0} n - ( {p}_{1} {n}_{1} + {p}_{2} {n}_{2} ) ] ( Δ d - 1 ) + {p}_{3} {n}_{3}}{1 - p} \geq 0.$$

The second equation may be obtained by substituting (18). The inequality follows from the facts that p₀n−(p₁n₁+p₂n₂)>0, Δd≧1, and n₃≧0, and the equality holds when Δd=1 and n₃≧0.

When the video sequence is large enough, the compatibility criterion (7) may be satisfied. In an embodiment, no frame with priority 2 may be generated after the beginning of the video sequence. Moreover, since the left hand side of (3) is strictly greater than the right hand side, the expected number of transmission attempts decreases using the approach disclosed herein. Thus, transmission opportunities may be saved for cross traffic.

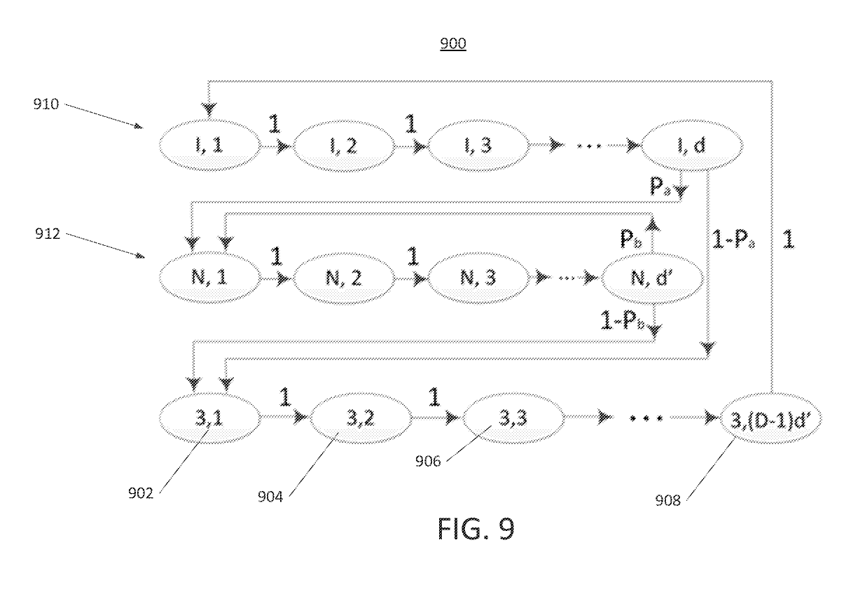

In an embodiment, except the beginning of the video sequence, no frame may be assigned priority 2. A frame with priority 1 may be followed by another frame with priority 1 when the packets of the former are transmitted successfully. According to the algorithm disclosed herein, the priority may not change within a frame. Even if a packet of a frame with priority 1 is dropped, the remaining packets of the same frame may have the same priority and the packets of the subsequent frame may be assigned priority 3. A frozen interval may include D−1 subsequent frames with priority 3, one or more (e.g., each) of which may be encoded into d′ packets. The first (D−1)d′−1 packets may be followed by another packet with priority 3 with probability 1, and the last one may be followed by a packet with priority 1, which may belong to the next IDR frame, with probability 1. This process may be modeled by the discrete-time Markov chain 900 shown in FIG. 9.

In FIG. 9, the states 902, 904, 906, 908 may represent the (D−1)d′ packets with priority 3 in a frozen interval. The states in the first two rows 910, 912 may represent the d and d′ packets of an IDR frame and a non-IDR frame with priority 1, respectively, where the state (I, i) may be for the i^{th} packet of the IDR frame, and the state (N, j) may be for the j^{th} packet of the non-IDR frame with priority 1. After a frozen interval, it may be followed by d packets of an IDR frame with priority 1. If the d packets are transmitted successfully, they may be followed by d′ packets of a non-IDR frame. Otherwise, they may initialize a new frozen interval. After the transmission of a non-IDR frame, it may be followed by another non-IDR frame unless the transmission fails. Pₐ and P_{b} may be the probabilities that the transmissions of an IDR frame and a non-IDR frame with priority 1 are successful, respectively. The transmission of an IDR frame may be successful, for example, if the d packets of the IDR frame are transmitted successfully. For a packet, the packet loss rate may be p₁, since it has priority 1. Accordingly,

Pₐ=(1−p₁)^{d}. (19)

Non-IDR frames may have priority 1. The probability P_{b} may be given by

P_{b}=(1−p₁)^{d′}. (20)

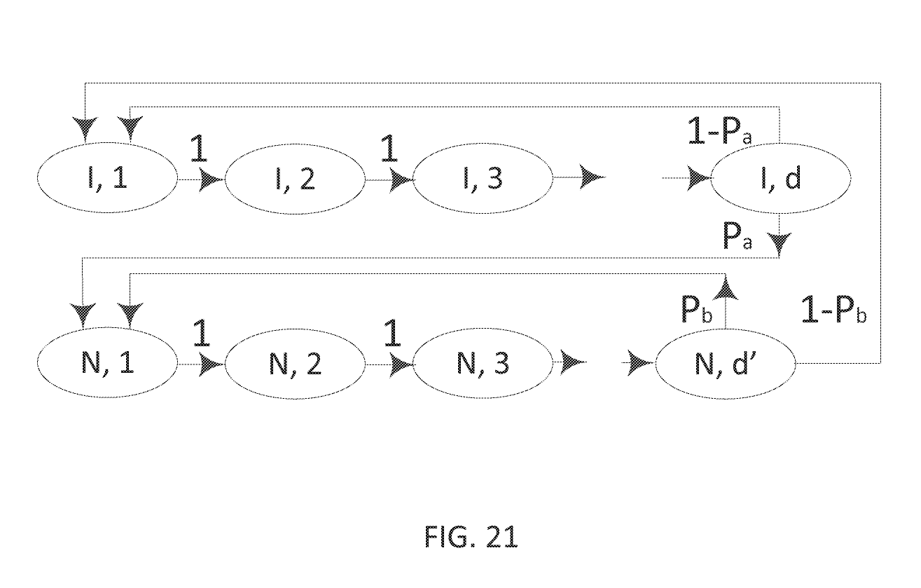

When D=1, no frame may be assigned priority 3, and the states I nthe last row of FIG. 9 may not be present. If a frame is dropped in transmission, it may be followed (e.g., immediately) by another IDR frame. The discrete time Markov chain may become the model illustrated in FIG. 21. The following derivation may be based on the model shown in FIG. 9. The derivation may be suitable when D=1. q_{I,i}, q_{N,j} and q_{3,k}, for 1≦i≦d, 1≦j≦d′ and 1≦k≦(D−1)d′, may be a stationary distribution of the Markov chain. q_{I,1}=q_{I,2}= . . . =q_{I,d}, q_{N,1}=q_{N,2}= . . . =q_{N,d′} and q_{3,1}=q_{3,2}= . . . =q_{3,(D-1)d′}. Furthermore,

q_{I,1}=q_{3,(D-1)d′} (21)

q_{N,1}=Pₐq_{I,d}+P_{b}q_{N,d′} (22)

q_{3,1}=(1−Pₐ)q_{I,d}+(1−P_{b})q_{N,d′} (23)

From the above equations,

$$\begin{matrix}{q}_{I , i} = {q}_{3 , 1} & ( 24 ) \\ {q}_{N , j} = \frac{{P}_{a}}{1 - {P}_{b}} {q}_{3 , 1} & ( 25 )\end{matrix}$$

From the normalization condition

dq_{I,1}+d′q_{N,1}+(D−1)d′q_{3,1}=1,

It may be obtained that

$${q}_{3 , 1} = \frac{1 - {P}_{b}}{[ d + ( D - 1 ) {d}^{′} ] ( 1 - {P}_{b} ) + {P}_{a} {d}^{′}} . \qquad ( 26 )$$

q₃ may be the probability that a packet belongs to an IDR frame, which may be given by

$${q}_{3} = {\sum }_{i = 1}^{( D - 1 ) {d}^{′}} {q}_{3 , i} = \frac{( D - 1 ) {d}^{′} ( 1 - {P}_{b} )}{[ d + ( D - 1 ) {d}^{′} ] ( 1 - {P}_{b} ) + {P}_{a} {d}^{′}} .$$

In a video sequence containing n₁+n₂+n₃ packets, the expected number of packets that may belong to an IDR frame may be obtained by n′₁=q₁(n₁+n₂+n₃). From (11),

$$\begin{matrix}{N}_{f}^{′} = ( \frac{{n}_{I}^{′}}{d} - 1 ) D \\ < \frac{{n}_{I}^{′} D}{d} \\ = \frac{{q}_{I} ( {n}_{1} + {n}_{2} + {n}_{3} ) D}{d} \\ = \frac{D ( 1 - {P}_{b} ) ( {n}_{1} + {n}_{2} + {n}_{3} )}{[ d + ( D - 1 ) {d}^{′} ] ( 1 - {P}_{b} ) + {P}_{a} {d}^{′}} \\ < \frac{D ( 1 - {P}_{b} ) n}{[ d + ( D - 1 ) {d}^{′} ] ( 1 - {P}_{b} ) + {P}_{a} {d}^{′}}\end{matrix} \qquad ( 27 )$$

where the last inequality may follow from the fact that n₁+n₂+n₃<n. By Taylor's theorem, the probability Pₐ may be expressed as

$$\begin{matrix}{p}_{a} = {( 1 - {p}_{1} )}^{d} \\ = 1 - {dp}_{1} + \frac{d ( d - 1 )}{2} {( 1 - ξ )}^{d - 2} {p}_{1}^{2}\end{matrix}$$

where 0≦ξ≦p₁≦1. Thus,

$$1 - {dp}_{1} \leq {P}_{a} \leq 1 - {dp}_{1} + \frac{d ( d - 1 )}{2} {p}_{1}^{2} . \\ Similarly , \\ {d}^{′} {p}_{1} - \frac{{d}^{′} ( {d}^{′} - 1 )}{2} {p}_{1}^{2} \leq 1 - {P}_{b} \leq {d}^{′} {p}_{1} .$$

Applying the above bounds, inequality (27) may be expressed as

$$\begin{matrix}{N}_{f}^{′} < \frac{D {d}^{′} {p}_{1} n}{[ d + ( D - 1 ) {d}^{′} ] ( {d}^{′} {p}_{1} - \frac{{d}^{′} ( {d}^{′} - 1 )}{2} {p}_{1}^{2} ) + ( 1 - {dp}_{1} ) {d}^{′}} \\ = \frac{D {p}_{1} n}{[ d + ( D - 1 ) {d}^{′} ] ( {p}_{1} - \frac{{d}^{′} - 1}{2} {p}_{1}^{2} ) - {dp}_{1} + 1} \\ = \frac{D {p}_{0} n}{[ d + ( D - 1 ) {d}^{′} ] ( {p}_{0} - \frac{{d}^{′} - 1}{2} {p}_{0} {p}_{1} ) - {dp}_{0} + \frac{{p}_{0}}{{p}_{1}}} \\ < \frac{{N}_{f}}{[ ( d + ( D - 1 ) {d}^{′} ) ( 1 - \frac{{d}^{′} - 1}{2} {p}_{1} ) - d ] {p}_{0} + 1} ,\end{matrix} \qquad ( 28 )$$

where the last inequality follows from the fact that p₀>p₁ and N_{f}=Dp₀n. From inequalities (17) and (28), an upper bound for N′_{f} may be that

$${N}_{f}^{′} < min \{ {N}_{f} , \frac{{N}_{f}}{[ ( d + ( D - 1 ) {d}^{′} ) ( 1 - \frac{{d}^{′} - 1}{2} {p}_{1} ) - d ] {p}_{0} + 1} \} \qquad ( 29 )$$

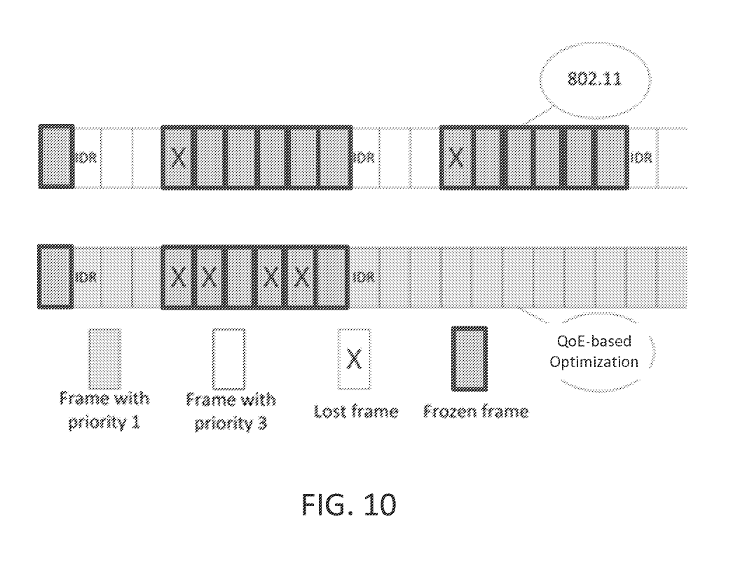

The expected freeze time may be reduced; the larger the length of frozen interval D is, the greater the gain compared to the IEEE 802.11 standard may be. FIG. 10 illustrates an example frozen frame comparison. The approach disclosed herein may concentrate packet losses to a small segment of a video sequence to improve the video quality.

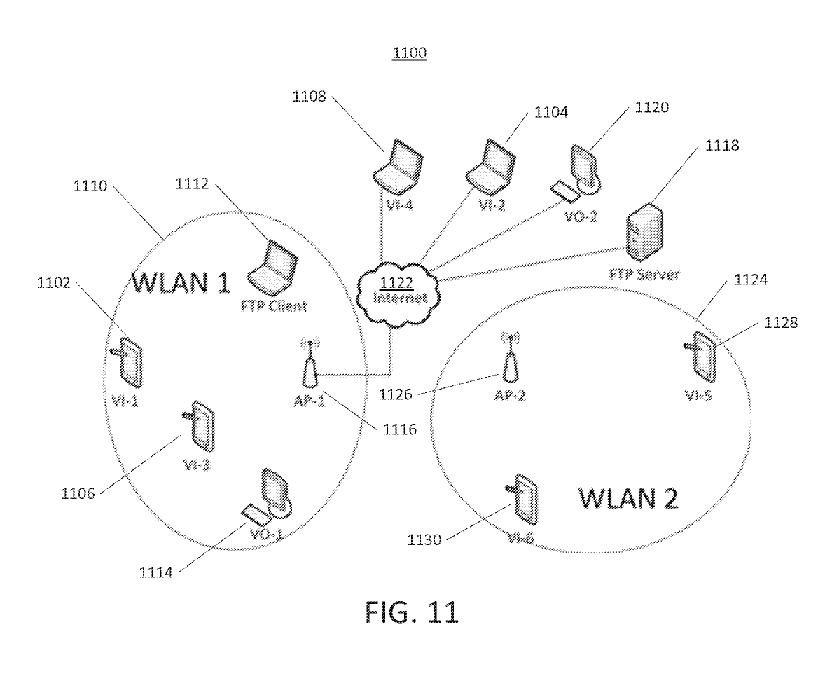

FIG. 11 illustrates an example network topology of a network 1100, which may include a video teleconferencing session with a QoE-based optimization betweeen devices 1102 and 1104 and other cross traffic. This cross traffic may include a voice session, an FTP session, and a video teleconferencing session without QoE-based optimization between devices 1106 and 1108. Video transmission may be one-way from device 1102 to device 1104, while the video teleconferencing may be two-way between devices 1106 and 1108. Devices 1102 and 1106 may be in the same WLAN 1110 with an FTP client 1112 and a voice user device 1114. An access point 1116 may communicate with devices 1104 and 1108, an FTP server 1118, and a voice user device 1120 through the Internet 1122, with a one-way delay of 100 ms in either direction. The H.264 video codec may be implemented for devices 1102 and 1104.

The retry limit R for the packets may be set to 7, the default value in the IEEE 802.11 standard. Three levels of video priority may be assigned in video teleconferencing sessions with QoE-based optimization. For example, the corresponding retry limits may be (R₁, R₂, R₃)=(8,7,1). At the video sender, a packet may be discarded when its retry limit is exceeded. The video receiver may detect a packet loss when it receives the subsequent packets or it does not receive any packets for a time period. The video receiver may send the packet loss information to the video sender, for example, through RTCP, and an IDR frame may be generated after the RTCP feedback is received by the video sender. From the time of the lost frame until the next IDR frame is received, the video receiver may present frozen video.

The Foreman video sequence may be transmitted from device 1102 to device 1104. The frame rate may be 30 frames/sec, and the video duration may be 10 seconds, including 295 frames. The cross traffic may be generated by OPNET 17.1. For the cross video session from device 1106 to device 1108, the frame rate may be 30 frames/sec, and the outgoing and incoming stream frame sizes may be 8500 bytes. For the TCP session between the FTP client and server, the receive buffer may be set to 8760 bytes. The numerical results may be averaged over 100 seeds, and for each seed, the data may be collected from the 10-second duration of the Foreman sequence.

A WLAN 1124 may increase the error probability p. The WLAN 1124 may include an AP 1126 and two stations 1128 and 1130. The IEEE 802.11n WLANs 1110, 1124 may operate on the same channel. The data rates may be 13 Mbps, and the transmit powers may be 5 mW. The buffer sizes at the APs may be 1 Mbit. The numbers of spatial streams may be set to 1. The distances of the APs and the stations may be set to enable the hidden nodes problem. In the simulations, the distance between the two APs 1116, 1126 may be 300 meters, and the distances between device 1102 and AP 1116, and between AP 1126 and device 1128, may be 350 meters. A video teleconferencing session may be initiated between devices 1128 and 1130 through AP 1126. The frame rate may be 30 frames/sec, and both the incoming and outgoing stream frame sizes may be used to adjust the packet loss rate of the video teleconferencing session with QoE-based optimization operating at device 1102.

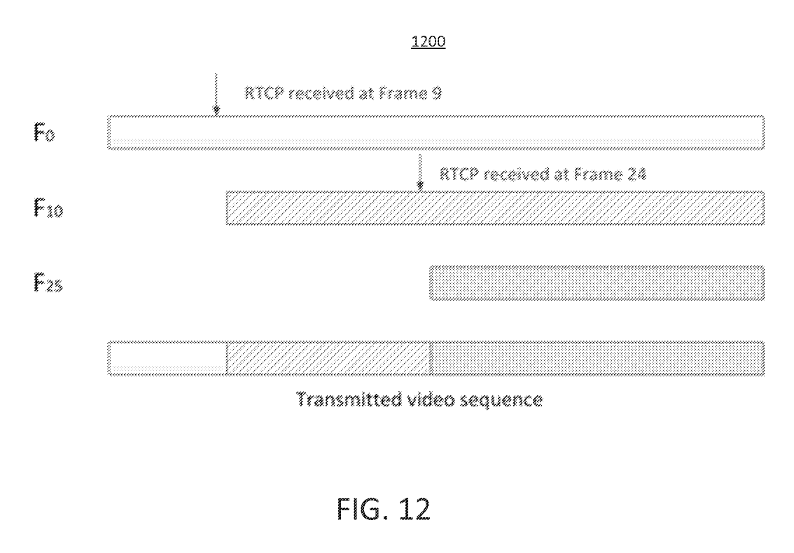

To simulate the dynamic IDR frame insertion triggered by reception of the packet loss feedback conveyed by RTCP packets in OPNET, a technique may be applied in which Fₙ, n=0, 1, 2, . . . , may be a video sequence beginning from frame n, where frame n may be an IDR frame and subsequent frames may be P-frames until the end of video sequence. Starting from the transmission of video sequence F₀, RTCP feedback may be received when frame i−1 is transmitted. After the transmission of the current frame, the video sequence Fᵢ may be used, which may cause the IDR frame insertion at frame i, and frame i and the subsequent frames of Fᵢ may be used to feed the video sender simulated in OPNET. FIG. 12 illustrates an example video sequence 1200, where RTCP feedback may be received when frames 9 and 24 are transmitted. In OPNET simulations, the sizes of the packets may be of interest. The possible video sequences Fₙ, n=0, 1, 2, . . . may be encoded, which may be a one-time effort. The sizes of the packets of the video sequences may be stored. When an RTCP feedback is received, the appropriate video sequence may be used.

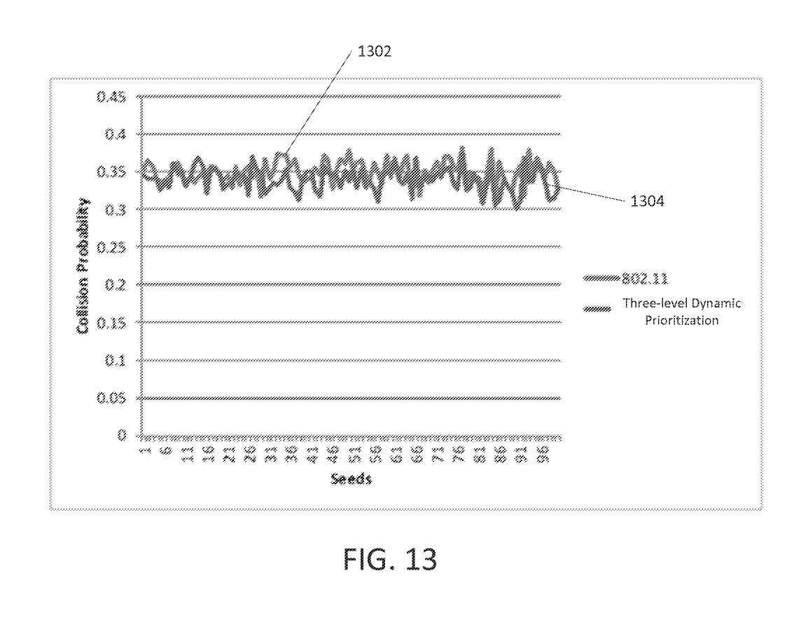

FIG. 13 illustrates example simulated collision probabilities p for 100 seeds, when the IEEE 802.11 standard and QoE-based optimization are used, as shown at reference numerals 1302 and 1304, respectively. The average collision probabilities may be 0.35 and 0.34 for the IEEE 802.11 standard and QoE-based optimization, respectively. The average absolute error may be 0.017 and the relative absolute error may be 4.9%. The simulation results may verify that it may be reasonable to use the collision probability when QoE-based optimization is applied as an approximation of collision probability when the IEEE 802.11 standard is applied.

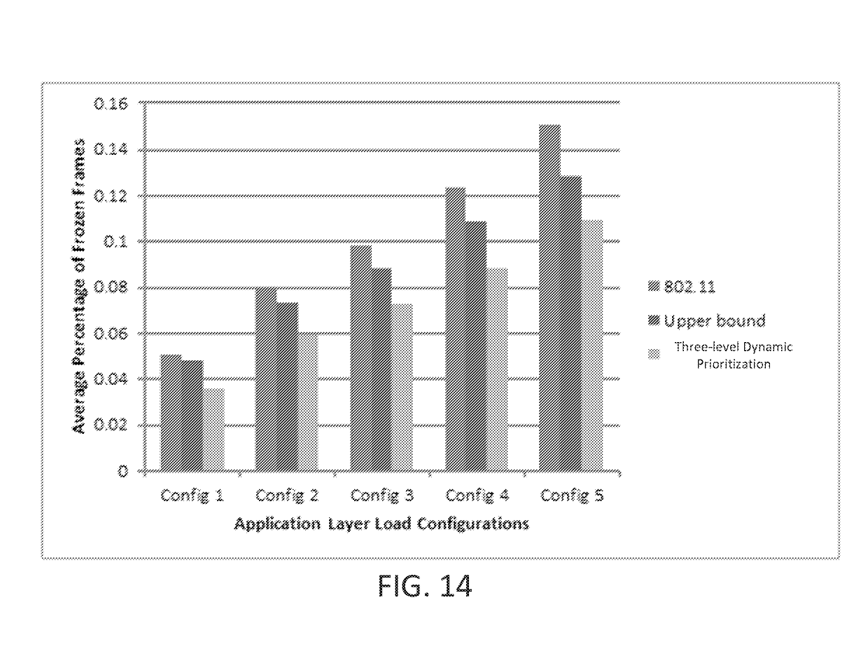

FIG. 14 illustrates example simulated percentages of frozen frames using the IEEE 802.11 standard and QoE-based optimization. For different application layer load configurations, the cross traffic between devices 1128 and 1130 may be tuned to obtain different packet loss rates, when the IEEE 802.11 standard is used. Example packet loss rates may be 0.0023, 0.0037, 0.0044, 0.0052 and 0.0058, for Configurations 1 to 5, respectively. Simulations may be run using QoE-based optimization with the same cross traffic configuration. FIG. 14 also illustrates the upper bound for QoE-based optimization in equation (29), where the parameters D, d, d′ and p₀ may be averaged from the simulation results. The average percentage of frozen frames of QoE-based optimization may be less than the upper bound. As the packet loss rate increases, the average percentage of frozen frames may increase regardless of whether QoE-based optimization is used, and the performance of QoE-based optimization may remain better than that of the corresponding value of the baseline method (e.g., no change to the IEEE 802.11 standard).

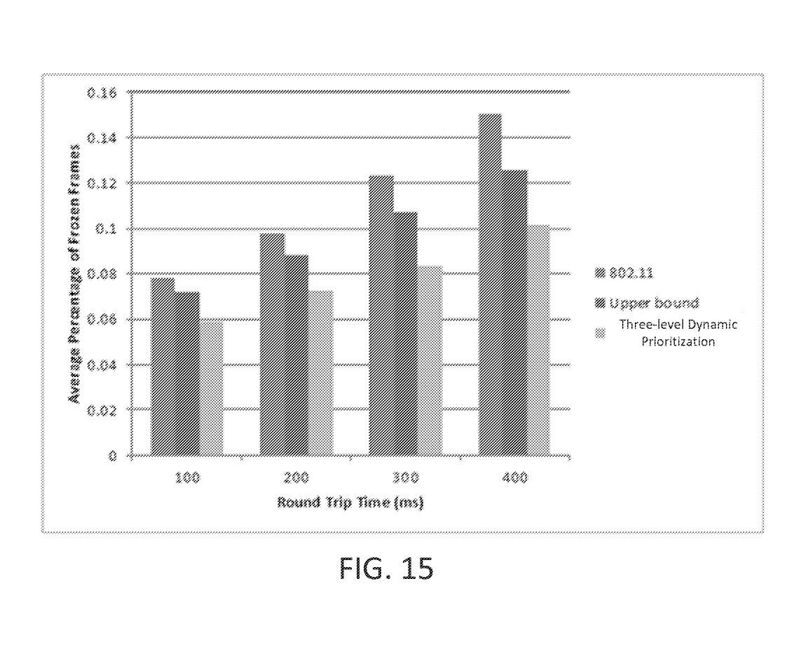

FIG. 15 illustrates example simulated average percentages of frozen frames for different RTTs between video sender and receiver, when the application layer load configuration 3 is applied. The feedback delay may be at least one RTT between video sender and receiver. When the feedback delay increases, the duration of frozen intervals may increase. More frames may be affected by packet losses. The percentage of frozen frames may increase as the RTT increases. From the upper bound in equation (29), the gain of QoE-based optimization compared with the IEEE 802.11 standard may increase when a larger RTT is applied. This may be confirmed by the numerical results in FIG. 15. When RTT is 100 ms, the average percentage of frozen frames using QoE-based optimization may be 24.5% less compared to that using the IEEE 802.11 standard. When the RTT is 400 ms, the gain may increase to 32.6%. The average percentages of frozen frames using QoE-based optimization may be less than the upper bound in equation (29).

Tables 2 and 4 illustrate example average throughputs for cross traffic in WLAN 1 using the IEEE 802.11 standard and QoE-based optimization, when the application layer load configuration 2 and 5 applied, respectively. In addition, the standard deviations for these two scenarios are listed in Tables 3 and 5, respectively. The throughput results for QoE-based optimization may be substantially similar to the IEEE 802.11 standard.

TABLE 2
Average throughputs for cross traffic with
application layer load configuration 2

Average Throughputs (Bytes/sec)

| | VI-3 | VI-4 | VO-1 | VO-2 | FTP |
|---|---|---|---|---|---|
| IEEE 802.11 | 254962 | 255686 | 3570 | 3617 | 40732 |
| QoE-based | 254766 | 255680 | 3492 | 3672 | 42985 |
| optimization | | | | | |

TABLE 3
Standard deviations of throughputs for cross traffic
with application layer load configuration 2

| | Standard Deviation of Throughputs (Bytes/sec) | | | | |
|---|---|---|---|---|---|
| | VI-3 | VI-4 | VO-1 | VO-2 | FTP |
| IEEE 802.11 | 9580 | 3749 | 2867 | 2808 | 29679 |
| QoE-based | 10786 | 3840 | 2853 | 2887 | 29544 |
| optimization | | | | | |

TABLE 4
Average throughputs for cross traffic with
application layer load configuration 5

| | Average Throughputs (Bytes/sec) | | | | |
|---|---|---|---|---|---|
| | VI-3 | VI-4 | VO-1 | VO-2 | FTP |
| IEEE 802.11 | 253806 | 255598 | 3659 | 3939 | 4726 |
| QoE-based | 254275 | 255687 | 3551 | 3682 | 4805 |
| optimization | | | | | |

TABLE 5
Standard deviation of throughputs for cross traffic
with application layer load configuration 5

| | Standard Deviation of Throughputs (Bytes/sec) | | | | |
|---|---|---|---|---|---|
| | VI-3 | VI-4 | VO-1 | VO-2 | FTP |
| IEEE 802.11 | 20420 | 4457 | 2866 | 2889 | 7502 |
| QoE-based | 20396 | 4546 | 2767 | 2873 | 7416 |
| optimization | | | | | |

Configuring (e.g., optimizing) expected video quality may be utilized. In configuring (e.g., optimizing) expected video quality, an AP (or STA) may make a decision on the QoS treatment for each packet based on the expected video quality. The AP may obtain the video quality information for the video packets, for example, from the video quality information database. The AP may look up the events that have happened to the video session to which the video packet belongs. The AP may determine how to treat the packets still waiting for transmission so as to configure (e.g., optimize) expected video quality.

In a WiFi network, packet losses may be random, and may not be fully controlled by the network. A probability measure for packet loss patterns may be provided. The probability measure may be constructed from the probability of failing to deliver a packet from a video traffic AC (AC_VI_i), i=1, 2, . . . , n, which may be measured and updated locally by a STA.

The AP and/or a STA may perform any of the following. The AP and/or STA may update the probability of failing to deliver a packet from traffic class AC_VI_i. The AP and/or STA may denote the probability as Pᵢ, i=1, . . . , n, for example, when the fate of a packet transmission attempt is known. The AP and/or STA may allocate the packets that are waiting for transmission to access categories AC_VI_i, i=1, . . . , n, for example, when a packet arrives. The AP and/or STA may evaluate the expected video quality. The AP and/or STA may select the packet allocation corresponding to the optimal expected video quality.

One or more criteria may be applied to achieve some global characteristics of the video telephony traffic. For example, a criterion may be a threshold on the sizes of the queues corresponding to the access categories AC_VI_i, i=1, . . . , n. A criterion may be selected to balance the queue sizes of one or more of the access categories AC_VI_i, i=1, . . . , n.

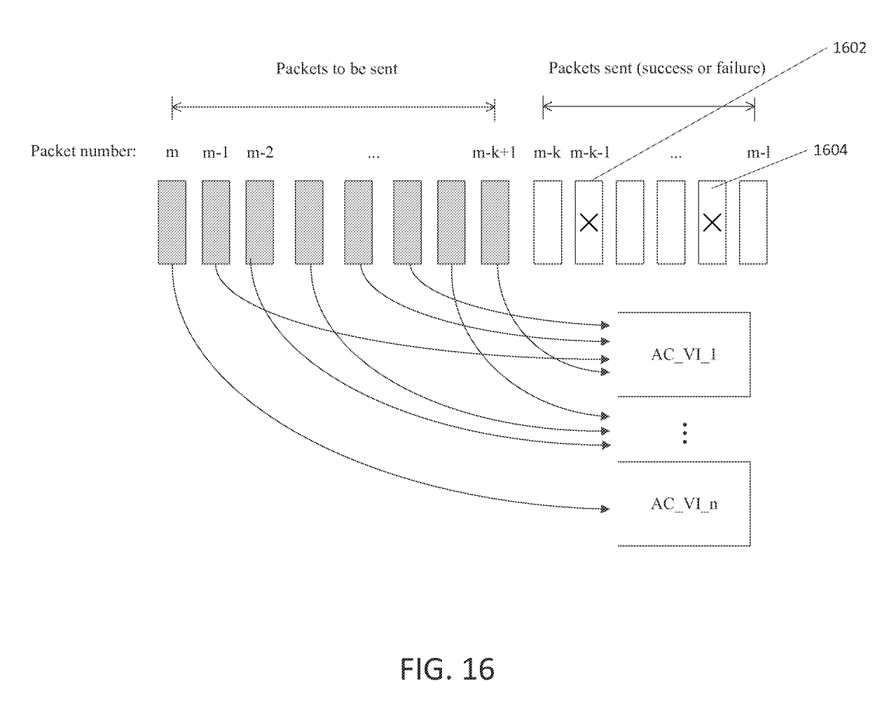

To allocate the packets to different access categories AC_VI_i, i=1, . . . , n, one or more methods may be used. FIG. 16 is a diagram illustrating an example reallocation method whereby packets may be reallocated to ACs upon packet arrival. The “X” on the packets 1602, 1604 in FIG. 16 may illustrate that the corresponding packet was not successfully delivered over the channel. In the example method illustrated in FIG. 16, packets waiting for transmission may be subject to packet reallocation. A packet allocation may determine the probability that the delivery of a packet will fail. If packet loss events are assumed to be independent, then the probability and/or the video quality corresponding to each possible packet loss pattern may be calculated. Averaging the packet loss patterns may provide an expected video quality.

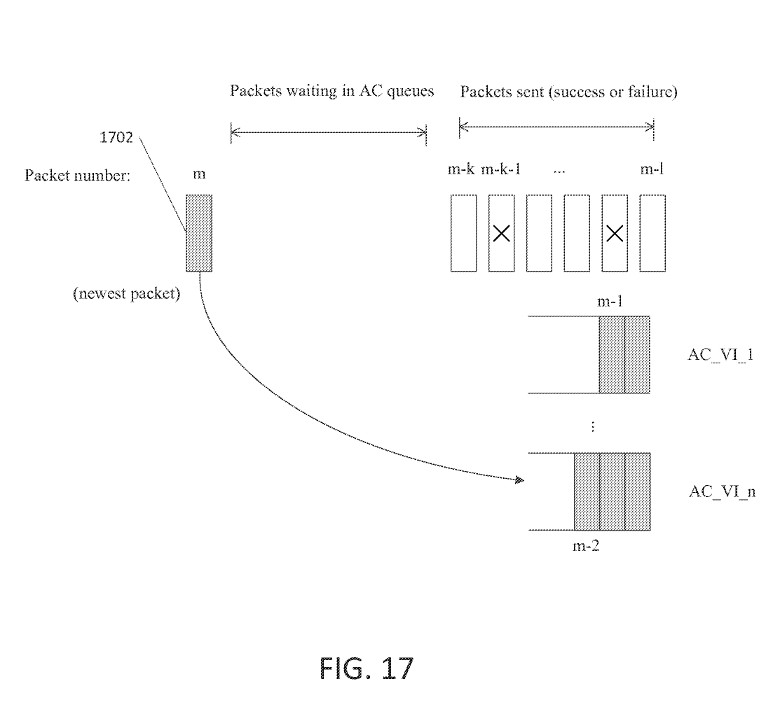

FIG. 17 is a diagram illustrating an example reallocation method in which the newest packets may be allocated to ACs upon packet arrival. In the example method of FIG. 17, when a new packet 1702 arrives, the assignment of the packet may be considered, e.g., without changing the allocation of other packets that are waiting for transmission. The method of FIG. 17 may reduce the computational overhead, for example, compared with the method of FIG. 16.

When a STA and/or an AP supports multiple video telephony traffic flows, the overall video quality of these flows may be configured (e.g., optimized). The STA and/or AP may track which video telephony flow a packet belongs to. The STA and/or AP may find the video packet allocation that provides the optimal overall video quality.

Enhancements for the DCF may be provided. The DCF may refer to the use of the DCF only or to the use of the DCF in conjunction with other components and/or functions. In the case of DCF, there may be no differentiation of data traffic. However, similar ideas that are disclosed herein in the context of EDCA may be adapted for DCF (e.g., DCF only MAC).

Video traffic (e.g., real-time video traffic) may be prioritized, for example, according to a static approach and/or a dynamic approach.

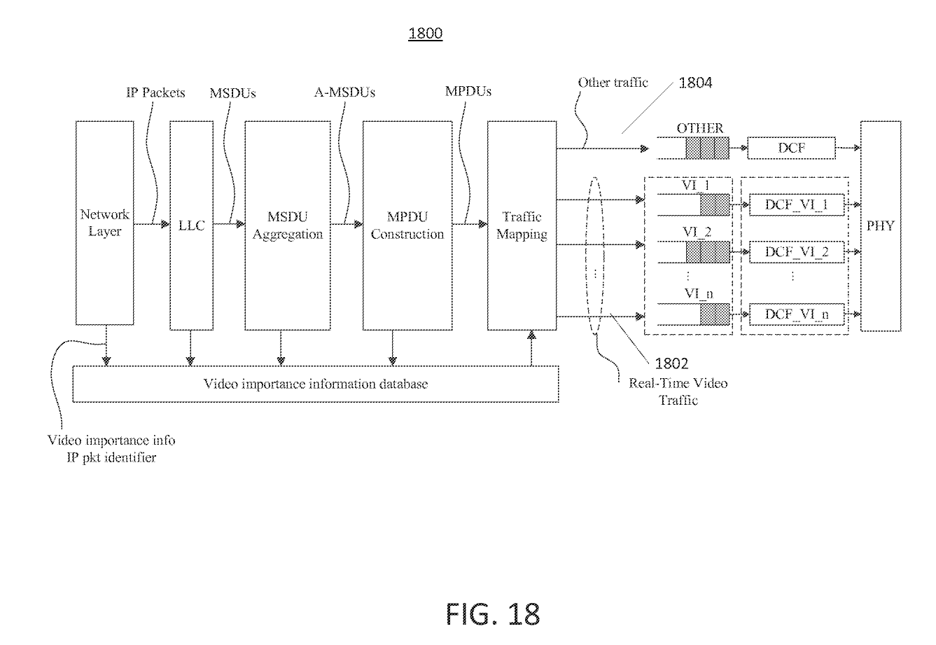

FIG. 18 is a diagram illustrating an example system architecture 1800 for an example static video traffic differentiation approach for DCF. The traffic may be separated into two or more categories, such as real-time video traffic 1802 and other types of traffic 1804 (e.g., denoted as OTHER), for example. Within the real-time video traffic category 1802, the traffic may be further differentiated into sub-classes (e.g., importance levels) according to the relative importance of the video packets. For example, referring to FIG. 18, n sub-classes VI_1, VI_2, . . . , VI_n may be provided.

The contention window may be defined based on importance level. The range of the CW, which may be [CWmin, CWmax], may be partitioned into smaller intervals, for example, for compatibility. CW may vary in the interval [CWmin, CWmax]. A backoff timer may be drawn randomly from the interval [0, CW].

For the real-time video traffic sub-classes VI_1, VI_2, . . . , VI_n, the video traffic carried by VI_i may be considered more important than that carried by V_j for i<j. The interval [CWmin, CWmax] may be partitioned into n intervals, which may or may not have equal lengths. If the intervals have equal lengths, then, for VI_j, its CW(VI_i) may vary in the interval:

[ceiling(CWmin+(i−1)*d), floor(CWmin+i*d)]

where ceiling( ) may be the ceiling function, and floor( ) may be the floor function, and d=(CWmax−CWmin)/n.

The distribution of the contention window for video traffic as a whole may be kept the same.

If the amount of traffic of different types of real-time video traffic types is not equal, then the interval [CWmin, CWmax] may be partitioned unequally, for example, such that the small intervals resulting from the partition may be proportional (e.g., inversely proportional) to the respective amounts of traffic of each traffic class. The traffic amounts may be monitored and/or estimated by a STA and/or an AP. For example, if the traffic for a particular class is higher, then the contention window interval may be made smaller. For example, if a sub-class (e.g., importance level) has more traffic, then the CW interval for that sub-class may be increased, for example, so that contention may be handled more efficiently.

The retransmission limits may be defined based on importance level (e.g., sub-class). There may not be differentiation of the attributes dot11LongRetryLimit and dot11ShortRetryLimit according to the traffic classes. The concepts disclosed herein with respect to EDCA may be adopted for DCF.

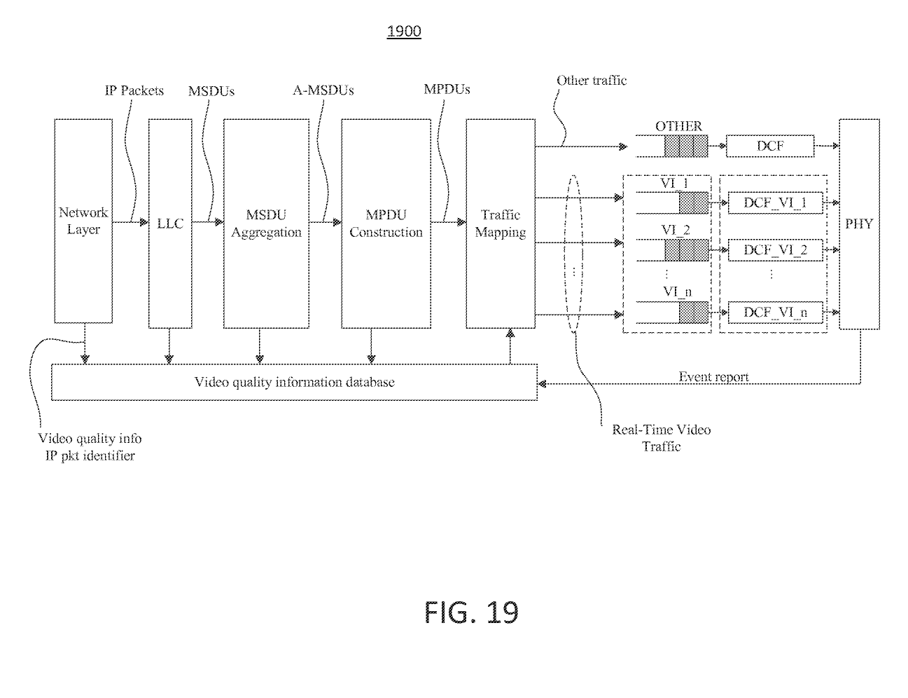

FIG. 19 is a diagram illustrating an example system architecture 1900 for an example dynamic video traffic differentiation approach for DCF. The concepts disclosed herein in the context of dynamic video traffic differentiation for EDCA may be applied to DCF. The concepts may be modified by replacing the labels AC_VI_i with VI_i, for i=1, 2, . . . , n.

The HCCA enhancements may be defined based on importance level (e.g., sub-class). HCCA may be a centralized approach to medium access (e.g., resource allocation). HCCA may be similar to the resource allocation in a cellular system. Like in the case of EDCA, prioritization for real-time video traffic in the case of HCCA can take two or more approaches, for example, a static approach and/or a dynamic approach.

In a static approach, the design parameters for EDCA may not be utilized. How the importance of a video packet is indicated may be the same as disclosed herein in the context of EDCA. The importance information may be passed to the AP, which may schedule the transmission of the video packet.

In HCCA, the scheduling may be performed on a per flow basis, for example, where the QoS expectation may be carried in the traffic specification (TSPEC) field of a management frame. The importance information in TSPEC may be the result of negotiation between the AP and a STA. In order to differentiate within a traffic flow, information about the importance of individual packets may be utilized. The AP may apply a packet mapping scheme and/or pass the video quality/importance information from the network layer to the MAC layer.

In the static approach, the AP may consider the importance of individual packets. In the dynamic approach, the AP may consider what has happened to the previous packets of a flow to which the packet under consideration belongs.

PHY enhancements may be provided. The modulation and coding set (MCS) selection for multiple input/multiple output (MIMO) may be selected (e.g., adopted), for example, with the goal of configuring (e.g., optimizing) the QoE of real-time video. The adaptation may occur at the PHY layer. The decision on which MCS may be used may be made at the MAC layer. The MAC enhancements described herein may be extended to include the PHY enhancements. For example, in the case of EDCA, the AC mapping function may be expanded to configure (e.g., optimize) the MCS for the video telephony traffic. A static approach and a dynamic approach may be utilized.

In the case of HCCA, the scheduler at the AP may decide which packet will access the channel, and what MCS may be used for transmitting that packet, for example, so that the video quality is configured (e.g., optimized).

The MCS selection may include the selection of modulation type, coding rate, MIMO configuration (e.g., spatial multiplexing or diversity), etc. For example, if a STA has a very weak link, then the AP may select a low order modulation scheme, a low coding rate, and/or diversity MIMO mode.

Video importance/quality information may be provided. The video importance/quality information may be provided by the video sender. The video importance/quality information may be put in the IP packet header so that the routers (e.g., AP serves analogous function for traffic going to the STAs) may access it. The DSCP field and/or the IP packet extension field may be utilized, for example, for IPv4.

The first six bits of the Traffic Class field may serve as the DSCP indicator, for example, for IPv6. An extension header may be defined to carry video importance/quality information, for example, for IPv6.

Packet mapping and encryption handling may be provided. Packet mapping may be performed utilizing a table lookup. A STA and/or AP may build a table that maps the IP packet to the A-MPDU.

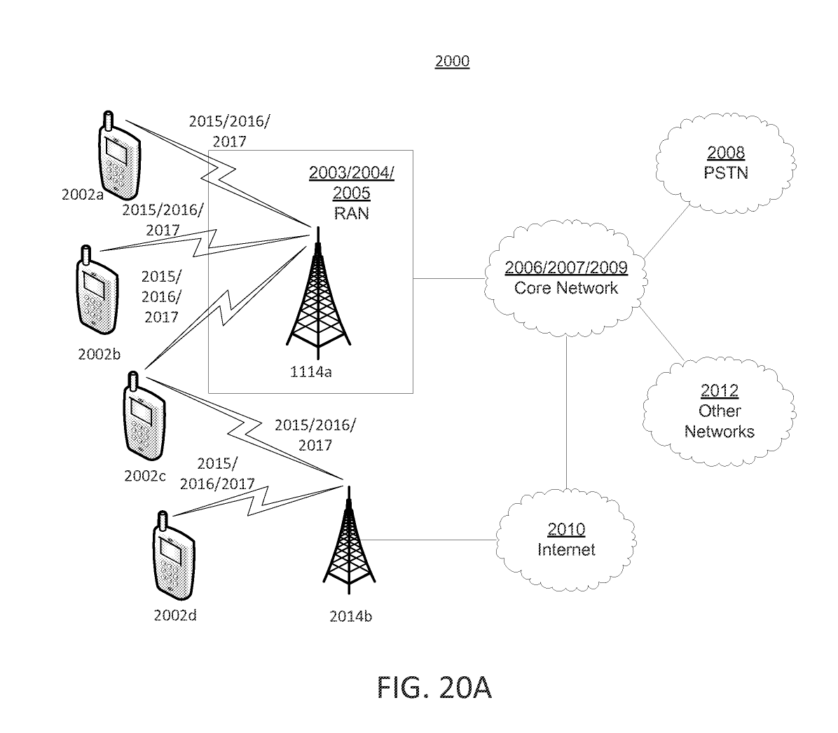

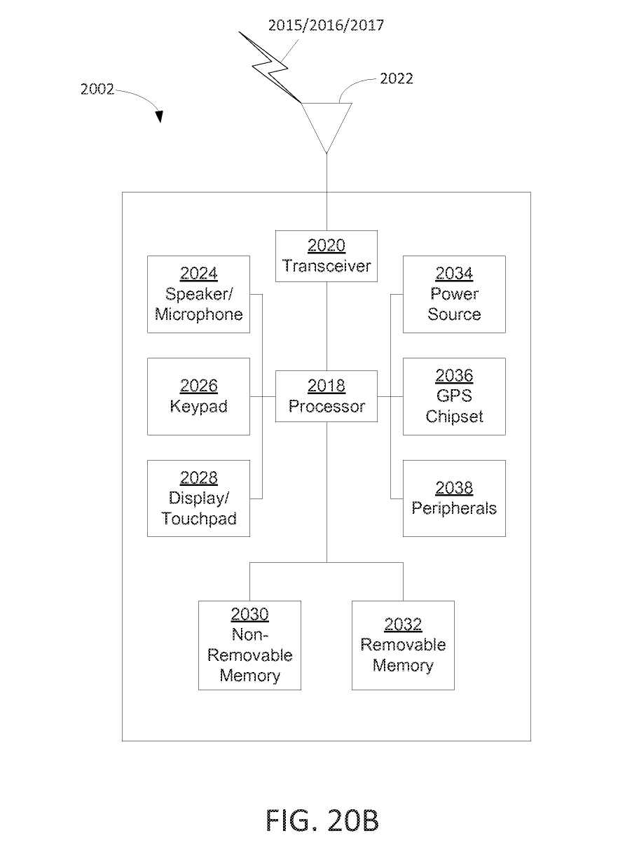

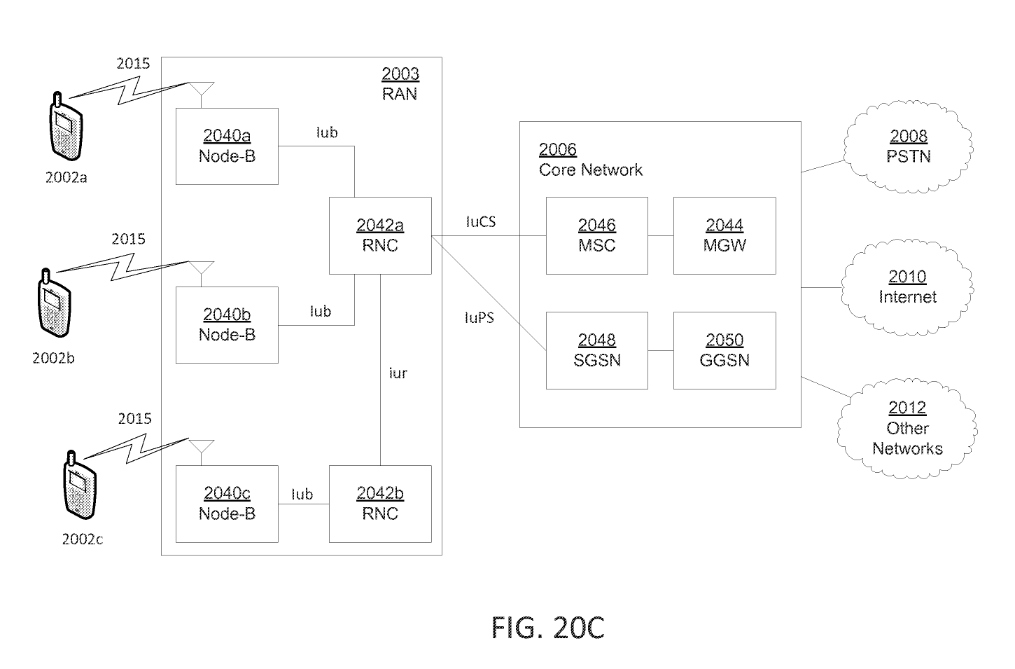

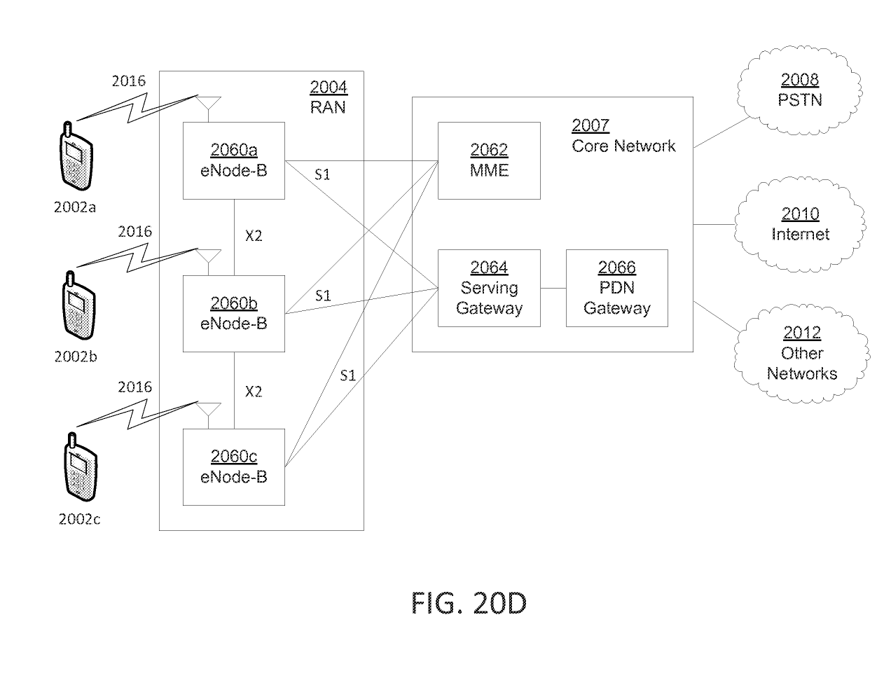

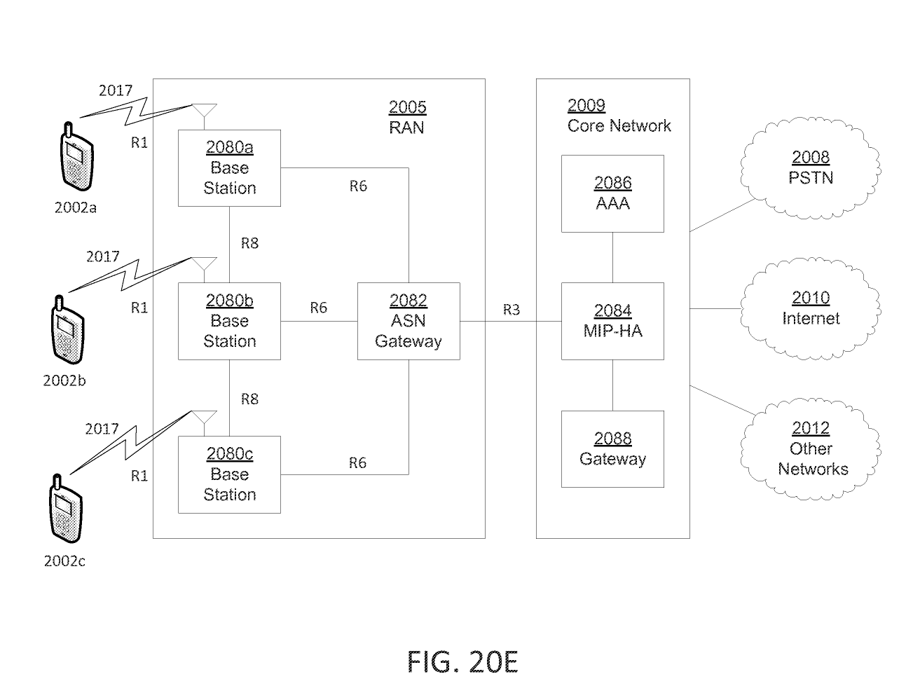

FIG. 20A is a diagram of an example communications system 2000 in which one or more disclosed embodiments may be implemented. The communications system 2000 may be a multiple access system that provides content, such as voice, data, video, messaging, broadcast, etc., to multiple wireless users. The communications system 2000 may enable multiple wireless users to access such content through the sharing of system resources, including wireless bandwidth. For example, the communications system 2000 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 20A, the communications system 2000 may include wireless transmit/receive units (WTRUs) 2002a, 2002b, 2002c, and/or 2002d (which generally or collectively may be referred to as WTRU 2002), a radio access network (RAN) 2003/2004/2005, a core network 2006/2007/2009, a public switched telephone network (PSTN) 2008, the Internet 2010, and other networks 2012, though it will be appreciated that the disclosed embodiments contemplate any number of WTRUs, base stations, networks, and/or network elements. Each of the WTRUs 2002a, 2002b, 2002c, 2002d may be any type of device configured to operate and/or communicate in a wireless environment. By way of example, the WTRUs 2002a, 2002b, 2002c, 2002d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 2000 may also include a base station 2014a and a base station 2014b. Each of the base stations 2014a, 2014b may be any type of device configured to wirelessly interface with at least one of the WTRUs 2002a, 2002b, 2002c, 2002d to facilitate access to one or more communication networks, such as the core network 2006/2007/2009, the Internet 2010, and/or the networks 2012. By way of example, the base stations 2014a, 2014b may be a base transceiver station (BTS), a Node-B, an eNode B, a Home Node B, a Home eNode B, a site controller, an access point (AP), a wireless router, and the like. While the base stations 2014a, 2014b are each depicted as a single element, it will be appreciated that the base stations 2014a, 2014b may include any number of interconnected base stations and/or network elements.

The base station 2014a may be part of the RAN 2003/2004/2005, which may also include other base stations and/or network elements (not shown), such as a base station controller (BSC), a radio network controller (RNC), relay nodes, etc. The base station 2014a and/or the base station 2014b may be configured to transmit and/or receive wireless signals within a particular geographic region, which may be referred to as a cell (not shown). The cell may further be divided into cell sectors. For example, the cell associated with the base station 2014a may be divided into three sectors. Thus, in one embodiment, the base station 2014a may include three transceivers, e.g., one for each sector of the cell. In another embodiment, the base station 2014a may employ multiple-input multiple output (MIMO) technology and, therefore, may utilize multiple transceivers for each sector of the cell.

The base stations 2014a, 2014b may communicate with one or more of the WTRUs 2002a, 2002b, 2002c, 2002d over an air interface 2015/2016/2017, which may be any suitable wireless communication link (e.g., radio frequency (RF), microwave, infrared (IR), ultraviolet (UV), visible light, etc.). The air interface 2015/2016/2017 may be established using any suitable radio access technology (RAT).

More specifically, as noted above, the communications system 2000 may be a multiple access system and may employ one or more channel access schemes, such as CDMA, TDMA, FDMA, OFDMA, SC-FDMA, and the like. For example, the base station 2014a in the RAN 2003/2004/2005 and the WTRUs 2002a, 2002b, 2002c, 2002d may implement a radio technology such as Universal Mobile Telecommunications System (UMTS) Terrestrial Radio Access (UTRA), which may establish the air interface 2015/2016/2017 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 2014a and the WTRUs 2002a, 2002b, 2002c, 2002d may implement a radio technology such as Evolved UMTS Terrestrial Radio Access (E-UTRA), which may establish the air interface 2015/2016/2017 using Long Term Evolution (LTE) and/or LTE-Advanced (LTE-A).

In other embodiments, the base station 2014a and the WTRUs 2002a, 2002b, 2002c, 2002d may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 2014b in FIG. 20A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 2014b and the WTRUs 2002c, 2002d may implement a radio technology such as IEEE 802.11 to establish a wireless local area network (WLAN). In another embodiment, the base station 2014b and the WTRUs 2002c, 2002d may implement a radio technology such as IEEE 802.15 to establish a wireless personal area network (WPAN). In yet another embodiment, the base station 2014b and the WTRUs 2002c, 2002d may utilize a cellular-based RAT (e.g., WCDMA, CDMA2000, GSM, LTE, LTE-A, etc.) to establish a picocell or femtocell. As shown in FIG. 20A, the base station 2014b may have a direct connection to the Internet 2010. Thus, the base station 2014b may not be required to access the Internet 2010 via the core network 2006/2007/2009.

The RAN 2003/2004/2005 may be in communication with the core network 2006/2007/2009, which may be any type of network configured to provide voice, data, applications, and/or voice over internet protocol (VoIP) services to one or more of the WTRUs 2002a, 2002b, 2002c, 2002d. For example, the core network 2006/2007/2009 may provide call control, billing services, mobile location-based services, pre-paid calling, Internet connectivity, video distribution, etc., and/or perform high-level security functions, such as user authentication. Although not shown in FIG. 20A, it will be appreciated that the RAN 2003/2004/2005 and/or the core network 2006/2007/2009 may be in direct or indirect communication with other RANs that employ the same RAT as the RAN 2003/2004/2005 or a different RAT. For example, in addition to being connected to the RAN 2003/2004/2005, which may be utilizing an E-UTRA radio technology, the core network 2006/2007/2009 may also be in communication with another RAN (not shown) employing a GSM radio technology.

The core network 2006/2007/2009 may also serve as a gateway for the WTRUs 2002a, 2002b, 2002c, 2002d to access the PSTN 2008, the Internet 2010, and/or other networks 2012. The PSTN 2008 may include circuit-switched telephone networks that provide plain old telephone service (POTS). The Internet 2010 may include a global system of interconnected computer networks and devices that use common communication protocols, such as the transmission control protocol (TCP), user datagram protocol (UDP) and the internet protocol (IP) in the TCP/IP internet protocol suite. The networks 2012 may include wired or wireless communications networks owned and/or operated by other service providers. For example, the networks 2012 may include another core network connected to one or more RANs, which may employ the same RAT as the RAN 2003/2004/2005 or a different RAT.

Some or all of the WTRUs 2002a, 2002b, 2002c, 2002d in the communications system 2000 may include multi-mode capabilities, e.g., the WTRUs 2002a, 2002b, 2002c, 2002d may include multiple transceivers for communicating with different wireless networks over different wireless links. For example, the WTRU 2002c shown in FIG. 20A may be configured to communicate with the base station 2014a, which may employ a cellular-based radio technology, and with the base station 2014b, which may employ an IEEE 802 radio technology.

FIG. 20B is a system diagram of an example WTRU 2002. As shown in FIG. 20B, the WTRU 2002 may include a processor 2018, a transceiver 2020, a transmit/receive element 2022, a speaker/microphone 2024, a keypad 2026, a display/touchpad 2028, non-removable memory 2030, removable memory 2032, a power source 2034, a global positioning system (GPS) chipset 2036, and other peripherals 2038. It will be appreciated that the WTRU 2002 may include any sub-combination of the foregoing elements while remaining consistent with an embodiment. Also, embodiments contemplate that the base stations 2014a and 2014b, and/or the nodes that base stations 2014a and 2014b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 20B and described herein.

The processor 2018 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 2018 may perform signal coding, data processing, power control, input/output processing, and/or any other functionality that enables the WTRU 2002 to operate in a wireless environment. The processor 2018 may be coupled to the transceiver 2020, which may be coupled to the transmit/receive element 2022. While FIG. 20B depicts the processor 2018 and the transceiver 2020 as separate components, it will be appreciated that the processor 2018 and the transceiver 2020 may be integrated together in an electronic package or chip. A processor, such as the processor 2018, may include integrated memory (e.g., WTRU 2002 may include a chipset that includes a processor and associated memory). Memory may refer to memory that is integrated with a processor (e.g., processor 2018) or memory that is otherwise associated with a device (e.g., WTRU 2002). The memory may be non-transitory. The memory may include (e.g., store) instructions that may be executed by the processor (e.g., software and/or firmware instructions). For example, the memory may include instructions that, when executed, may cause the processor to implement one or more of the implementations described herein.

The transmit/receive element 2022 may be configured to transmit signals to, or receive signals from, a base station (e.g., the base station 2014a) over the air interface 2015/1116/2017. For example, in one embodiment, the transmit/receive element 2022 may be an antenna configured to transmit and/or receive RF signals. In another embodiment, the transmit/receive element 2022 may be an emitter/detector configured to transmit and/or receive IR, UV, or visible light signals, for example. In yet another embodiment, the transmit/receive element 2022 may be configured to transmit and receive both RF and light signals. It will be appreciated that the transmit/receive element 2022 may be configured to transmit and/or receive any combination of wireless signals.

In addition, although the transmit/receive element 2022 is depicted in FIG. 20B as a single element, the WTRU 2002 may include any number of transmit/receive elements 1122. More specifically, the WTRU 2002 may employ MIMO technology. Thus, in one embodiment, the WTRU 2002 may include two or more transmit/receive elements 1122 (e.g., multiple antennas) for transmitting and receiving wireless signals over the air interface 2015/2016/2017.

The transceiver 2020 may be configured to modulate the signals that are to be transmitted by the transmit/receive element 2022 and to demodulate the signals that are received by the transmit/receive element 2022. As noted above, the WTRU 2002 may have multi-mode capabilities. Thus, the transceiver 2020 may include multiple transceivers for enabling the WTRU 2002 to communicate via multiple RATs, such as UTRA and IEEE 802.11, for example.

The processor 2018 of the WTRU 2002 may be coupled to, and may receive user input data from, the speaker/microphone 2024, the keypad 2026, and/or the display/touchpad 2028 (e.g., a liquid crystal display (LCD) display unit or organic light-emitting diode (OLED) display unit). The processor 2018 may also output user data to the speaker/microphone 2024, the keypad 2026, and/or the display/touchpad 2028. In addition, the processor 2018 may access information from, and store data in, any type of suitable memory, such as the non-removable memory 2030 and/or the removable memory 2032. The non-removable memory 2030 may include random-access memory (RAM), read-only memory (ROM), a hard disk, or any other type of memory storage device. The removable memory 2032 may include a subscriber identity module (SIM) card, a memory stick, a secure digital (SD) memory card, and the like. In other embodiments, the processor 2018 may access information from, and store data in, memory that is not physically located on the WTRU 2002, such as on a server or a home computer (not shown).

The processor 2018 may receive power from the power source 2034, and may be configured to distribute and/or control the power to the other components in the WTRU 2002. The power source 2034 may be any suitable device for powering the WTRU 2002. For example, the power source 2034 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 2018 may also be coupled to the GPS chipset 2036, which may be configured to provide location information (e.g., longitude and latitude) regarding the current location of the WTRU 2002. In addition to, or in lieu of, the information from the GPS chipset 2036, the WTRU 2002 may receive location information over the air interface 2015/2016/2017 from a base station (e.g., base stations 2014a, 2014b) and/or determine its location based on the timing of the signals being received from two or more nearby base stations. It will be appreciated that the WTRU 2002 may acquire location information by way of any suitable location-determination method while remaining consistent with an embodiment.

The processor 2018 may further be coupled to other peripherals 2038, which may include one or more software and/or hardware modules that provide additional features, functionality and/or wired or wireless connectivity. For example, the peripherals 2038 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 20C is a system diagram of the RAN 2003 and the core network 2006 according to an embodiment. As noted above, the RAN 2003 may employ a UTRA radio technology to communicate with the WTRUs 2002a, 2002b, 2002c over the air interface 2015. The RAN 2003 may also be in communication with the core network 2006. As shown in FIG. 20C, the RAN 2003 may include Node-Bs 2040a, 2040b, 2040c, which may each include one or more transceivers for communicating with the WTRUs 2002a, 2002b, 2002c over the air interface 2015. The Node-Bs 2040a, 2040b, 2040c may each be associated with a particular cell (not shown) within the RAN 2003. The RAN 2003 may also include RNCs 2042a, 2042b. It will be appreciated that the RAN 2003 may include any number of Node-Bs and RNCs while remaining consistent with an embodiment.

As shown in FIG. 20C, the Node-Bs 2040a, 2040b may be in communication with the RNC 2042a. Additionally, the Node-B 2040c may be in communication with the RNC2042b. The Node-Bs 2040a, 2040b, 2040c may communicate with the respective RNCs 2042a, 2042b via an Iub interface. The RNCs 2042a, 2042b may be in communication with one another via an Iur interface. Each of the RNCs 2042a, 2042b may be configured to control the respective Node-Bs 2040a, 2040b, 2040c to which it is connected. In addition, each of the RNCs 2042a, 2042b may be configured to carry out or support other functionality, such as outer loop power control, load control, admission control, packet scheduling, handover control, macrodiversity, security functions, data encryption, and the like.

The core network 2006 shown in FIG. 20C may include a media gateway (MGW) 2044, a mobile switching center (MSC) 2046, a serving GPRS support node (SGSN) 2048, and/or a gateway GPRS support node (GGSN) 2050. While each of the foregoing elements are depicted as part of the core network 2006, it will be appreciated that any one of these elements may be owned and/or operated by an entity other than the core network operator.

The RNC 2042a in the RAN 2003 may be connected to the MSC 2046 in the core network 2006 via an IuCS interface. The MSC 2046 may be connected to the MGW 2044. The MSC 2046 and the MGW 2044 may provide the WTRUs 2002a, 2002b, 2002c with access to circuit-switched networks, such as the PSTN 2008, to facilitate communications between the WTRUs 2002a, 2002b, 2002c and traditional land-line communications devices.

The RNC 2042a in the RAN 2003 may also be connected to the SGSN 2048 in the core network 2006 via an IuPS interface. The SGSN 2048 may be connected to the GGSN 2050. The SGSN 2048 and the GGSN 2050 may provide the WTRUs 2002a, 2002b, 2002c with access to packet-switched networks, such as the Internet 2010, to facilitate communications between and the WTRUs 2002a, 2002b, 2002c and IP-enabled devices.

As noted above, the core network 2006 may also be connected to the networks 2012, which may include other wired or wireless networks that are owned and/or operated by other service providers.

FIG. 20D is a system diagram of the RAN 2004 and the core network 2007 according to an embodiment. As noted above, the RAN 2004 may employ an E-UTRA radio technology to communicate with the WTRUs 2002a, 2002b, 2002c over the air interface 2016. The RAN 2004 may also be in communication with the core network 2007.

The RAN 2004 may include eNode-Bs 2060a, 2060b, 2060c, though it will be appreciated that the RAN 2004 may include any number of eNode-Bs while remaining consistent with an embodiment. The eNode-Bs 2060a, 2060b, 2060c may each include one or more transceivers for communicating with the WTRUs 2002a, 2002b, 2002c over the air interface 2016. In one embodiment, the eNode-Bs 2060a, 2060b, 2060c may implement MIMO technology. Thus, the eNode-B 2060a, for example, may use multiple antennas to transmit wireless signals to, and receive wireless signals from, the WTRU 2002a.

Each of the eNode-Bs 2060a, 2060b, 2060c may be associated with a particular cell (not shown) and may be configured to handle radio resource management decisions, handover decisions, scheduling of users in the uplink and/or downlink, and the like. As shown in FIG. 20D, the eNode-Bs 2060a, 2060b, 2060c may communicate with one another over an X2 interface.

The core network 2007 shown in FIG. 20D may include a mobility management gateway (MME) 2062, a serving gateway 2064, and a packet data network (PDN) gateway 2066. While each of the foregoing elements are depicted as part of the core network 2007, it will be appreciated that any one of these elements may be owned and/or operated by an entity other than the core network operator.

The MME 2062 may be connected to each of the eNode-Bs 2060a, 2060b, 2060c in the RAN 2004 via an S1 interface and may serve as a control node. For example, the MME 2062 may be responsible for authenticating users of the WTRUs 2002a, 2002b, 2002c, bearer activation/deactivation, selecting a particular serving gateway during an initial attach of the WTRUs 2002a, 2002b, 2002c, and the like. The MME 2062 may also provide a control plane function for switching between the RAN 2004 and other RANs (not shown) that employ other radio technologies, such as GSM or WCDMA.

The serving gateway 2064 may be connected to each of the eNode-Bs 2060a, 2060b, 2060c in the RAN 2004 via the S1 interface. The serving gateway 2064 may generally route and forward user data packets to/from the WTRUs 2002a, 2002b, 2002c. The serving gateway 2064 may also perform other functions, such as anchoring user planes during inter-eNode B handovers, triggering paging when downlink data is available for the WTRUs 2002a, 2002b, 2002c, managing and storing contexts of the WTRUs 2002a, 2002b, 2002c, and the like.

The serving gateway 2064 may also be connected to the PDN gateway 2066, which may provide the WTRUs 2002a, 2002b, 2002c with access to packet-switched networks, such as the Internet 2010, to facilitate communications between the WTRUs 2002a, 2002b, 2002c and IP-enabled devices.

The core network 2007 may facilitate communications with other networks. For example, the core network 2007 may provide the WTRUs 2002a, 2002b, 2002c with access to circuit-switched networks, such as the PSTN 2008, to facilitate communications between the WTRUs 2002a, 2002b, 2002c and traditional land-line communications devices. For example, the core network 2007 may include, or may communicate with, an IP gateway (e.g., an IP multimedia subsystem (IMS) server) that serves as an interface between the core network 2007 and the PSTN 2008. In addition, the core network 2007 may provide the WTRUs 2002a, 2002b, 2002c with access to the networks 2012, which may include other wired or wireless networks that are owned and/or operated by other service providers.

FIG. 20E is a system diagram of the RAN 2005 and the core network 2009 according to an embodiment. The RAN 2005 may be an access service network (ASN) that employs IEEE 802.16 radio technology to communicate with the WTRUs 2002a, 2002b, 2002c over the air interface 2017. As will be further discussed below, the communication links between the different functional entities of the WTRUs 2002a, 2002b, 2002c, the RAN 2005, and the core network 2009 may be defined as reference points.

As shown in FIG. 20E, the RAN 2005 may include base stations 2080a, 2080b, 2080c, and an ASN gateway 2082, though it will be appreciated that the RAN 2005 may include any number of base stations and ASN gateways while remaining consistent with an embodiment. The base stations 2080a, 2080b, 2080c may each be associated with a particular cell (not shown) in the RAN 2005 and may each include one or more transceivers for communicating with the WTRUs 2002a, 2002b, 2002c over the air interface 2017. In one embodiment, the base stations 2080a, 2080b, 2080c may implement MIMO technology. Thus, the base station 2080a, for example, may use multiple antennas to transmit wireless signals to, and receive wireless signals from, the WTRU 2002a. The base stations 2080a, 2080b, 2080c may also provide mobility management functions, such as handoff triggering, tunnel establishment, radio resource management, traffic classification, quality of service (QoS) policy enforcement, and the like. The ASN gateway 2082 may serve as a traffic aggregation point and may be responsible for paging, caching of subscriber profiles, routing to the core network 2009, and the like.

The air interface 2017 between the WTRUs 2002a, 2002b, 2002c and the RAN 2005 may be defined as an R1 reference point that implements the IEEE 802.16 specification. In addition, each of the WTRUs 2002a, 2002b, 2002c may establish a logical interface (not shown) with the core network 2009. The logical interface between the WTRUs 2002a, 2002b, 2002c and the core network 2009 may be defined as an R2 reference point, which may be used for authentication, authorization, IP host configuration management, and/or mobility management.

The communication link between each of the base stations 2080a, 2080b, 2080c may be defined as an R8 reference point that includes protocols for facilitating WTRU handovers and the transfer of data between base stations. The communication link between the base stations 2080a, 2080b, 2080c and the ASN gateway 2082 may be defined as an R6 reference point. The R6 reference point may include protocols for facilitating mobility management based on mobility events associated with each of the WTRUs 2002a, 2002b, 2002c.

As shown in FIG. 20E, the RAN 2005 may be connected to the core network 2009. The communication link between the RAN 2005 and the core network 2009 may defined as an R3 reference point that includes protocols for facilitating data transfer and mobility management capabilities, for example. The core network 2009 may include a mobile IP home agent (MIP-HA) 2084, an authentication, authorization, accounting (AAA) server 2086, and a gateway 2088. While each of the foregoing elements are depicted as part of the core network 2009, it will be appreciated that any one of these elements may be owned and/or operated by an entity other than the core network operator.

The MIP-HA may be responsible for IP address management, and may enable the WTRUs 2002a, 2002b, 2002c to roam between different ASNs and/or different core networks. The MIP-HA 2084 may provide the WTRUs 2002a, 2002b, 2002c with access to packet-switched networks, such as the Internet 2010, to facilitate communications between the WTRUs 2002a, 2002b, 2002c and IP-enabled devices. The AAA server 2086 may be responsible for user authentication and for supporting user services. The gateway 2088 may facilitate interworking with other networks. For example, the gateway 2088 may provide the WTRUs 2002a, 2002b, 2002c with access to circuit-switched networks, such as the PSTN 2008, to facilitate communications between the WTRUs 2002a, 2002b, 2002c and traditional land-line communications devices. In addition, the gateway 2088 may provide the WTRUs 2002a, 2002b, 2002c with access to the networks 2012, which may include other wired or wireless networks that are owned and/or operated by other service providers.

Although not shown in FIG. 20E, it will be appreciated that the RAN 2005 may be connected to other ASNs and the core network 2009 may be connected to other core networks. The communication link between the RAN 2005 the other ASNs may be defined as an R4 reference point, which may include protocols for coordinating the mobility of the WTRUs 2002a, 2002b, 2002c between the RAN 2005 and the other ASNs. The communication link between the core network 2009 and the other core networks may be defined as an R5 reference, which may include protocols for facilitating interworking between home core networks and visited core networks.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed:

1. A method comprising:
receiving a video packet associated with a video stream from an application layer;
assigning an importance level to the video packet, the importance level being associated with a transmission priority of the video packet, wherein the importance level is associated with a retransmission limit of the video packet; and
sending the video packet according to the retransmission limit.

2. The method of claim 1, further comprising assigning the retransmission limit based at least in part on a network event.

3. The method of claim 2, further comprising assigning the retransmission limit based at least in part on a packet loss event.

4. The method of claim 2, further comprising assigning the retransmission limit based at least in part on a congestion level.

5. The method of claim 1, further comprising assigning the video packet a high importance level if the video packet is an Instantaneous Decoder Refresh (IDR) frame.

6. The method of claim 1, further comprising assigning the video packet a high priority level if the video packet is subsequent to an Instantaneous Decoder Refresh (IDR) frame and prior to a packet loss after the IDR frame.

7. The method of claim 1, further comprising assigning the video packet a high priority level if the video packet occurs in a time interval following an IDR frame during which a compatibility constraint is satisfied.

8. The method of claim 7, wherein the compatibility constraint requires the load resulting from the video traffic of all priority levels to be less than a threshold.

9. The method of claim 1, further comprising assigning the video packet a low priority level if the video packet is subsequent to packet loss and prior to the first IDR frame following the packet loss.

10. The method of claim 1, wherein the video stream comprises a plurality of video packets, and wherein a first subset of the plurality of video packets is associated with a first importance level, a second subset of the plurality of video packets is associated with a second importance level, and a third subset of the plurality of video packets is associated with a third importance level.

11. A device for transmitting a video packet, the device comprising:
a processor; and
a memory comprising processor-executable instructions that, when executed by the processor, cause the processor to
receive a video packet associated with a video stream from an application layer, the video packet characterized by an access category;
assign an importance level to the video packet, the importance level being associated with a transmission priority of the video packet, wherein the importance level is associated with a retransmission limit of the video packet; and
send the video packet according to the retransmission limit.

12. The device of claim 11, the memory comprising further processor-executable instructions for assigning the retransmission limit based at least in part on a network event.

13. The device of claim 12, the memory comprising further processor-executable instructions for assigning the retransmission limit based at least in part on a packet loss event.

14. The device of claim 12, the memory comprising further processor-executable instructions for assigning the retransmission limit based at least in part on a congestion level.

15. The device of claim 11, the memory comprising further processor-executable instructions for assigning the video packet a high priority level if the video packet is an Instantaneous Decoder Refresh (IDR) frame.

16. The device of claim 11, the memory comprising further processor-executable instructions for assigning the video packet a high priority level if the video packet is subsequent to an Instantaneous Decoder Refresh (IDR) frame and prior to a packet loss after the IDR frame.

17. The device of claim 11, the memory comprising further processor-executable instructions for assigning the video packet a high priority level if the video packet occurs in a time interval following an IDR frame during which a compatibility constraint is satisfied.

18. The device of claim 17, wherein the compatibility constraint requires the load resulting from the video traffic of all priority levels to be less than a threshold.

19. The device of claim 11, the memory comprising further processor-executable instructions for assigning the video packet a low priority level if the video packet is subsequent to packet loss and prior to the first IDR frame following the packet loss.

20. The device of claim 11, wherein the video stream comprises a plurality of video packets, and wherein a first subset of the plurality of video packets is associated with a first importance level, a second subset of the plurality of video packets is associated with a second importance level, and a third subset of the plurality of video packets is associated with a third importance level.
